(19) United States
(12) Patent Application Publication
(10) Pub. No.: US 2026/0135030 A1
(43) Pub. Date: May 14, 2026

(54) MAGNETIC ELEMENT AND POWER MODULE

(71) Applicant: Delta Electronics (Shanghai) CO., LTD., Shanghai (CN)

(72) Inventors: Quanguang CHEN, Shanghai (CN); Jinping ZHOU, Shanghai (CN); Le LIANG, Shanghai (CN)

(73) Assignee: Delta Electronics (Shanghai) CO., LTD., Shanghai (CN)

(21) Appl. No.: 19/383,964

(22) Filed: Nov. 10, 2025

(30) Foreign Application Priority Data
Nov. 11, 2024 (CN) 2024116095289

(51) Int. Cl. H01F 38/14; H01F 3/08; H01F 5/04; H01F 27/00; H01F 27/26; H01F 27/40; H01F 37/00

(52) U.S. Cl. CPC H01F 38/14; H01F 3/08; H01F 5/04; H01F 27/006; H01F 27/266; H01F 27/40; H01F 37/00; H01F 2005/043

(57) ABSTRACT

The present disclosure provides a magnetic element and a power module. The power module includes: at least one magnetic element and k first switch unit; the magnetic element includes: a magnetic core including a first surface and a second surface arranged oppositely; and n first winding and m second winding arranged in the magnetic core; n is greater than or equal to m; each first winding is arranged adjacent to a second winding; an effective cross-sectional area of each first winding is greater than that of each second winding; each first winding includes a first end for leading out a first pin on the first surface and a second end for leading out a second pin on the second surface; k first switch unit is arranged on the first surface, and each first switch unit is electrically connected to the first pin of the first winding.

### CROSS REFERENCE

This application is based upon and claims priority to Chinese Patent Application No. 2024116095289, filed on Nov. 11, 2024, the entire contents thereof are incorporated herein by reference.

### TECHNICAL FIELD

The present disclosure relates to the technical field of inductor, and in particular, to a magnetic element and power module.

### BACKGROUND

As the working speed of the central processing unit (CPU), graphics processing unit (GPU) and various integrated chips (ICs) is getting faster and faster, and the working current is getting larger and larger, the voltage regulator module (VRM) that supplies power to them has increasingly stringent requirements in terms of power density, efficiency, dynamic performance, etc., which poses a very high challenge to the design of VRM. In the voltage regulator module, the volume of the output inductor often accounts for the highest proportion, and the selection of the inductor's inductance also directly affects the efficiency and dynamic performance of the entire VRM. At present, as the power of GPU/CPU gradually increases, the reserved area of the VRM module is further reduced, while the output inductor accounts for a large proportion. The reserved space for the VRM is limited, thus it is difficult to accommodate the output inductor, and it also results in the low power density of the VRM. Therefore, a higher requirement is put forward on the power density of the VRM module.

It should be noted that the information disclosed in the above Background section is only used to enhance the understanding of the background of the present disclosure, and therefore may include information that does not constitute prior art known to those skilled in the art.

### SUMMARY

Other features and advantages of the present disclosure will become apparent through the detailed description below, or partially learned through the practice of the present disclosure.

According to the first aspect of the present disclosure, a magnetic element is provided, including:
a magnetic core, the magnetic core including a first surface and a second surface arranged opposite to each other; and
n first winding and m second winding arranged in the magnetic core;
where n is an integer greater than or equal to m, and m is an integer greater than or equal to 1;
each of the first winding is arranged adjacent to a second winding;
an effective cross-sectional area of each of the first winding is greater than an effective cross-sectional area of each of the second winding;
each of the first winding includes a first end and a second end, the first end of the first winding is used to lead out a first pin on the first surface, and the second end of the first winding is used to lead out a second pin on the second surface.

According to the second aspect of the present disclosure, a power module is also provided, including:
at least one magnetic element and k first switch unit;
where the magnetic element includes: a magnetic core, the magnetic core includes a first surface and a second surface arranged oppositely; and a first winding and b second windings arranged in the magnetic core;
where a is an integer greater than or equal to b, and b is an integer greater than or equal to 1; each of the first winding is arranged adjacent to a second winding; k is an integer greater than or equal to 1, and k is equal to a;
an effective cross-sectional area of each of the first winding is greater than an effective cross-sectional area of each of the second winding;
each of the first winding includes a first end and a second end, the first end of the first winding is used to lead out a first pin on the first surface, and the second end of the first winding is used to lead out a second pin on the second surface;
the k first switch unit is arranged on the first surface of the magnetic core, and each of the first switch unit is electrically connected to the first pin led out by a first winding on the first surface.

It should be understood that the above general description and the detailed description below are only exemplary and explanatory, and cannot limit the present disclosure.

### BRIEF DESCRIPTION OF THE DRAWINGS

The drawings herein, which are incorporated in and constitute a part of this specification, illustrate embodiments consistent with the present disclosure and, together with the specification, serve to explain the principles of the present disclosure. Obviously, the drawings described below are only some embodiments of the present disclosure. For those skilled in the art, other drawings can also be obtained based on these drawings without creative work.

FIG. 1 shows a structural schematic diagram of a magnetic element in an embodiment of the present disclosure;

FIG. 2 shows a structural schematic diagram of a magnetic element in some embodiments of the present disclosure;

FIG. 3 shows a schematic diagram of a distribution of magnetic lines of force in a magnetic element in an embodiment of the present disclosure;

FIG. 4 shows a schematic diagram of a size of a magnetic element in an embodiment of the present disclosure;

FIG. 5 shows a structural schematic diagram of a magnetic element in a specific embodiment of the present disclosure;

FIG. 6 shows a schematic diagram of a magnetic flux distribution of the magnetic element shown in FIG. 5 in a specific embodiment of the present disclosure;

FIG. 7 shows a side view schematic diagram of a winding distribution of the magnetic element shown in FIG. 5 in a specific embodiment of the present disclosure;

FIG. 8 shows a schematic diagram of an association relationship between a coupling coefficient K between the first winding of the first-phase inductor unit and the first winding of the second-phase inductor unit in the magnetic element shown in FIG. 5 and d1/d2 in a specific example of the present disclosure;

FIG. 9 shows a structural schematic diagram of an arrangement scheme of a magnetic core material between the first-phase inductor unit and the second-phase inductor unit of the magnetic element in a specific example of the present disclosure;

FIG. 10 shows a schematic top view of another arrangement scheme of the magnetic core material between the first-phase inductor unit and the second-phase inductor unit of the magnetic element in a specific example of the present disclosure;

FIG. 11 shows a schematic diagram of a magnetic flux flow after the magnetic core material between the first-phase inductor unit and the second-phase inductor unit of the magnetic element is arranged in the specific example of the present disclosure;

FIG. 12 shows a schematic diagram of a specific structure of the magnetic element in the specific embodiment of the present disclosure;

FIG. 13 shows a schematic diagram of a shape structure of the first winding and the second winding in the magnetic element in the specific embodiment of the present disclosure;

FIG. 14 shows a schematic diagram of the current flow direction of the magnetic element composed of the windings shown in FIG. 13 in the specific embodiment of the present disclosure;

FIG. 15 shows a structural schematic diagram of the magnetic element when the first winding of the first-phase inductor unit and the first winding of the second-phase inductor unit are close to each other in the specific embodiment of the present disclosure;

FIG. 16 shows a schematic diagram of the magnetic element composed of an 8-shaped magnetic core in a specific embodiment of the present disclosure

FIG. 17 shows a schematic diagram of another magnetic element composed of an 8-shaped magnetic core in a specific embodiment of the present disclosure;

FIG. 18 shows a side view schematic diagram of a magnetic element with PINs on both surfaces of the second winding in a specific embodiment of the present disclosure;

FIG. 19 shows a side view schematic diagram of a magnetic element with PINs on one surface of the second winding in a specific embodiment of the present disclosure;

FIG. 20 shows a structural schematic diagram of a magnetic element in another specific embodiment of the present disclosure;

FIG. 21 shows a structural schematic diagram of a power module in an embodiment of the present disclosure;

FIG. 22 shows a structural schematic diagram of a power module with a connection mode between a first switch unit and a magnetic element in a specific embodiment of the present disclosure;

FIG. 23 shows a structural schematic diagram of a power module with another connection mode between the first switch unit and the magnetic element in a specific embodiment of the present disclosure;

FIG. 24 shows a structural schematic diagram of a power module in a specific embodiment of the present disclosure;

FIG. 25 shows a structural schematic diagram in which the overlap rate of the projections of the first winding and the second winding on the vertical plane is 60% in some embodiments of the present disclosure;

FIG. 26 shows a schematic diagram of a top view and a side view of a magnetic element in a power module in which the second winding is bent in a specific embodiment of the present disclosure;

FIG. 27 shows a schematic diagram of a top view and a side view of a magnetic element in a power module in which the second winding is bent and the first winding is bent in a specific embodiment of the present disclosure;

FIG. 28 shows a schematic diagram of a top view and a side view of the magnetic element shown in FIG. 27 after adding insulating material in a specific embodiment of the present disclosure;

FIG. 29 shows a schematic diagram of a circuit connection of a power module in another specific embodiment of the present disclosure;

FIG. 30 shows a schematic diagram of a circuit connection of a power module included in a power supply system in an embodiment of the present disclosure; and

FIG. 31 shows the connection relationship between the inductor unit and the switch unit provided by the related art and the embodiment of the present disclosure respectively.

### DETAILED DESCRIPTION

The example embodiments will now be described more fully with reference to the accompanying drawings. However, the example embodiments can be implemented in a variety of forms and should not be construed as limited to the examples set forth herein; rather, these embodiments are provided so that the present disclosure will be more comprehensive and complete and the concepts of the example embodiments will be fully conveyed to those skilled in the art. The described features, structures, or characteristics may be combined in one or more embodiments in any suitable manner.

In addition, the drawings are only schematic illustrations of the present disclosure and are not necessarily drawn to scale. The same reference signs in the drawings represent the same or similar parts, and thus their repeated descriptions will be omitted. Some of the block diagrams shown in the drawings are functional entities and do not necessarily correspond to physically or logically independent entities. These functional entities may be implemented in software form, or in one or more hardware modules or integrated circuits, or in different networks and/or processor apparatuses and/or microcontroller apparatuses.

The specific implementations of the embodiments of the present disclosure will be described in detail below in conjunction with the accompanying drawings.

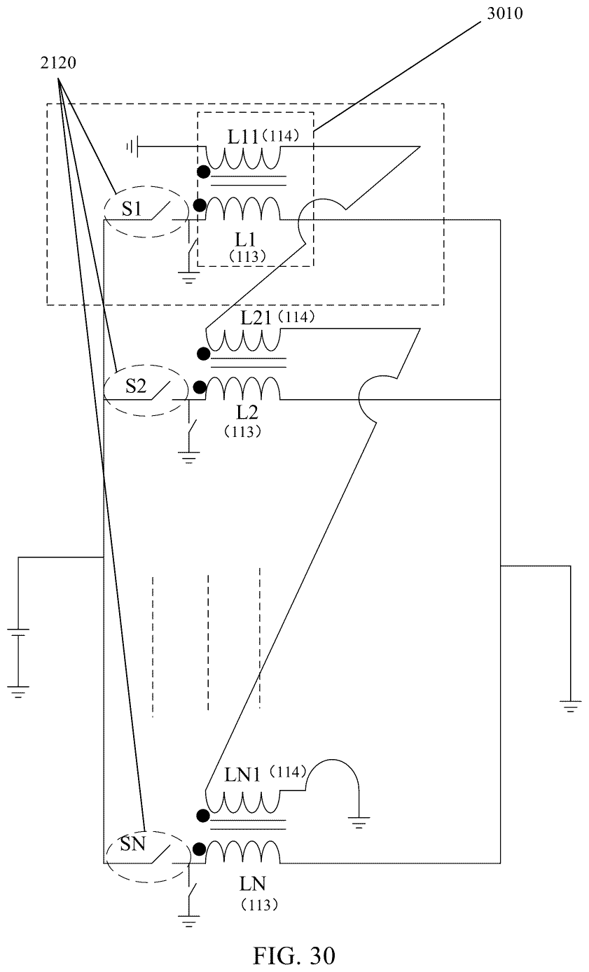

The applicant has found that a high inductance value of the inductor results in high efficiency of VRM but poor dynamic performance; conversely, a low inductance value is detrimental to efficiency but good for dynamic performance. A good solution is to use anti-coupled inductors, which can achieve both high steady-state inductance Lss and low dynamic inductance Ltr, meeting the requirements of high efficiency and high dynamics. Based on its basic principle, the coupled inductors can be divided into direct anti-coupled inductors and indirect anti-coupled inductors. Trans Inductor Voltage Regulator (TLVR) based on the indirect coupled principle, as shown in FIG. 30, has become a research hotspot in the VRM field due to its extremely high flexibility and scalability.

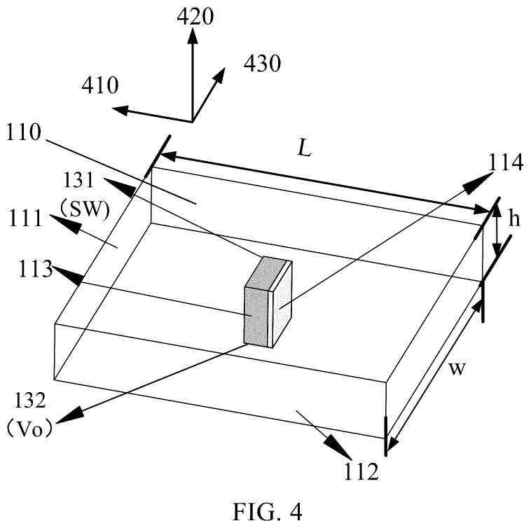

However, the indirect coupled inductors also have their challenging aspects. First, compared with the direct coupled inductors, the indirect coupled inductors have higher requirements for the saturation flux density Bs of magnetic materials because there is no mutual cancellation of DC magnetic flux, and their volumes are also larger. Second, due to the existence of the secondary winding, the indirect coupled inductors require more output terminals and interconnections, which poses higher challenges to the VRM structure and process. Third, as shown in FIG. 30, multi-phase indirect anti-coupling is shown, and the second windings (Lxx) of individual phase inductors are connected to each other at opposite-polarity terminals, thereby achieving indirect anti-coupling of the first winding of each phase inductor. In order to further reduce the volume, the same magnetic core can integrate multi-phase windings, which can lead to produce positive coupling between multi-phase windings, which is not conducive to the realization of anti-coupling. As shown in FIG. 4, reducing the positive coupling between multi-phase first windings is one of the problems solved by the embodiments of the present disclosure.

The inductor includes two windings, the first winding (Lx) of each phase is directly connected to the switch unit (Sx), and the second windings (Lxx) of individual phases are connected to each other through the opposite-polarity terminals to achieve coupling between phases. The first winding and the second winding are arranged adjacently to improve the coupling degree between the first winding and the second winding, but the first winding and the second winding of the inductor of the TLVR are coupled through AC magnetic flux, and its inductance is AC inductance, which is much larger than DC inductance. It can be seen from Lac×Idc=N×Bpeak×Ae that when Ae remains unchanged, the higher the inductance value under AC, the larger the Bpeak value, the larger the Bs of the required material, and the higher the requirement for the saturation ability of the material. Among them, Ae is the area of the magnetic core, Bpeak is the B value under Ipeak, and N is the number of turns of the first winding.

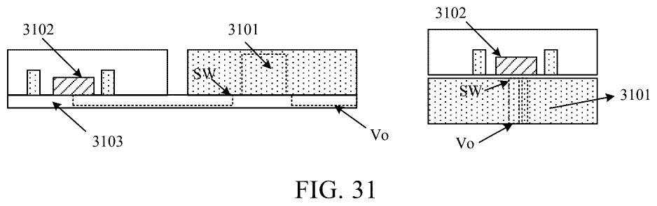

As the power of GPU/CPU gradually increases, the reserved area of the VRM module is further reduced. As shown in FIG. 31, at present, the inductor unit 3101 and the switch unit 3102 are set horizontally as shown in the left figure. The area of the VRM in the board 3103 accounts for a large proportion, and the switch unit 3102 is connected to the inductor SW and then is led out from Vo through the inductor winding. The path is long and the Directive Current Resistance (DCR) is large. As shown in the right figure, when they are stacked vertically, the path from the switch unit 3102 to Vo is short. The DCR is small. Therefore, the vertically stacked VRM module occupies a small area in the board, has high power density and low DCR loss. The vertical stacking requires the inductor pins to be led out on two opposite sides, so that one terminal of the inductor is directly connected to the switch unit and the other terminal is directly connected to the load.

The present disclosure provides a magnetic element and a power module, which at least to some extent overcomes the problems in the related art that the output inductor accounts for a large proportion, the reserved space for the VRM is limited and it is difficult to accommodate the output inductor, and the power density of the VRM is not high.

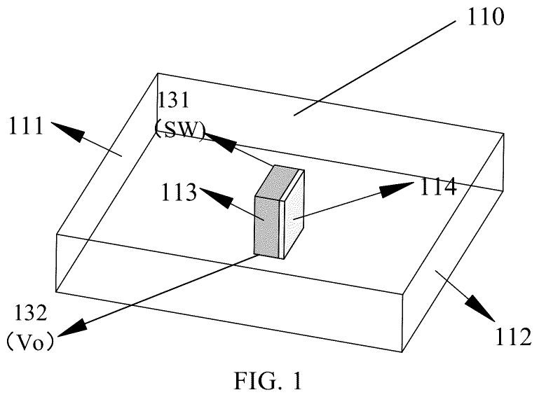

As shown in FIGS. 1 to 20, a magnetic element provided in an embodiment of the present disclosure includes:
a magnetic core 110, the magnetic core 110 includes a first surface 111 and a second surface 112 arranged opposite to each other; and
n first windings 113 and m second windings 114 arranged in the magnetic core 110; it should be noted that the first winding 113 is a first winding, and the second winding 114 is a second winding.

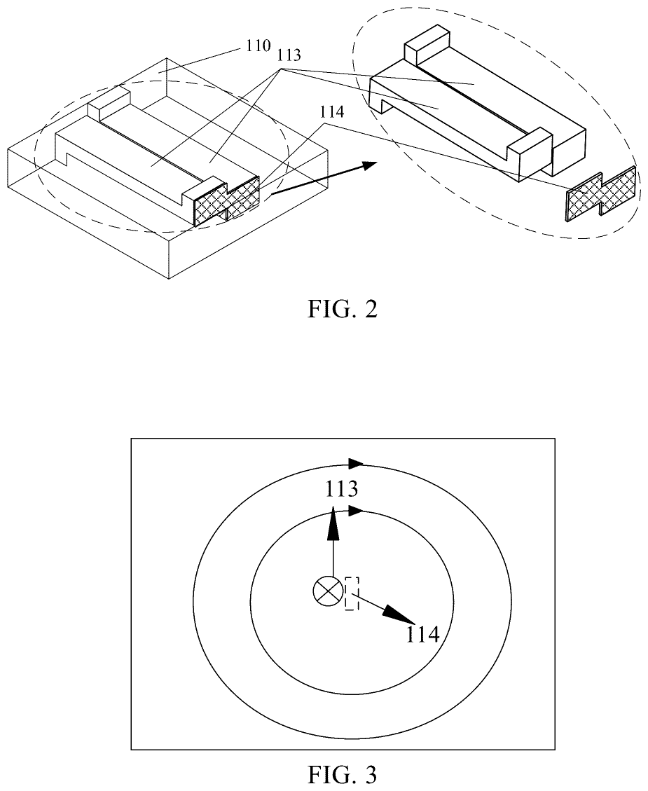

n is an integer greater than or equal to m, and m is an integer greater than or equal to 1. It should be noted that, in specific implementation, in some embodiments, n is equal to m, that is, the number of the first windings 113 and the number of the second windings 114 are the same. In other embodiments, n is greater than m, that is, the number of the first windings 113 is more than the number of the second windings 114, and multiple first windings 113 share one second winding 114. For example, as shown in FIG. 2, it may be n=2, m=1, and two first windings 113 share one second winding 114.

Each first winding 113 is arranged adjacent to a second winding 114; the adjacent arrangement means that there is no magnetic material between the first winding and the second winding of each phase. If there is magnetic material, the coupling effect between the first winding and the second winding will be reduced. At least one insulating layer is arranged between the first winding and the second winding of each phase, and the thickness of the insulating layer is at least 5 um. There is a section parallel to the first surface. On the section, the distance between two adjacent surfaces of the first winding and the second winding of the same phase in the first direction is the distance between the first winding and the second winding of each phase, and the distance is less than ⅕ of the length of the magnetic core along the first direction. The adjacent arrangement of the first winding and the second winding can reduce the length of the magnetic circuit, increase the inductance, and increase the coupling between the first winding and the second winding. The direction perpendicular to the first surface of the magnetic core is the second direction, and the direction of the straight line passing through the centroid of the first winding and the centroid of the second winding of the same phase on the section is the first direction, and the third direction is perpendicular to the first direction and the second direction at the same time. The first direction, the second direction and the third direction are perpendicular to each other. The first winding may be a primary winding, and the second winding may be a secondary winding.

The first windings 113 and the second windings 114 of at least two phases may be placed side by side. The side by side placement may be that the second windings of the two-phase inductor units may be on the inside or outside of the connection line of the two-phase first windings, or the two-phase second windings and the two-phase first windings are arranged interleavedly, and the two-phase second windings may not be arranged on the connection line of the two-phase first windings, for example, the two-phase second windings and the two-phase first windings are arranged in an array, the connection line of the two-phase second windings is parallel to the connection line of the two-phase first windings, and are arranged at one side of the connection line of the two-phase first windings, and the two-phase second windings are arranged adjacent to the first windings. It is also possible that one of the two includes the other setting, for example, the first winding 113 is arranged around the second winding 114. In specific implementation, an insulating layer is also arranged between the first winding 113 and the second winding 114 that are adjacently arranged to improve safety and avoid short circuit of the windings. It can be understood by those skilled in the art that the thickness of the insulating layer arranged between the first winding 113 and the second winding 114 that are arranged adjacently can be set according to actual conditions, for example, it may be 0.03 mm. The above thickness value is only an example and is not used to limit the protection scope of the present disclosure.

In some embodiments of the present disclosure, when the magnetic element includes multiple first windings and second windings, the multiple first windings and the multiple second windings may be arranged in an array or in a straight line, for example, 1221, 2112, 1212 or 2121, where 1 represents the first winding and 2 represents the second winding. It should be noted that one first winding and one second winding form a single-phase inductor unit, and the second winding is arranged in the middle, then the positive coupling coefficient is the same, that is, the spacing between the first windings of two phases is the same. In this case, the volume of the magnetic element can be reduced. The distance between the inductor units of different phases may be the same or different. Multiple first windings and multiple second windings may also be arranged in a non-linear manner, for example, in a diagonal arrangement.

The effective cross-sectional area of each first winding 113 is greater than the effective cross-sectional area of each second winding 114. When the winding is composed of a single conductor, the cross-sectional area of the single conductor is its effective cross-sectional area, and when the winding is formed by multiple conductors connected in parallel, the sum of the cross-sectional areas of the multiple conductors constituting the winding is its effective cross-sectional area. For example, when the first winding 113 is arranged around the second winding 114, the effective cross-sectional area of the first winding is the annular cross-sectional area of the current flowing through the first winding. It should be noted that in the specific implementation, the current flowing through the first winding 113 is mostly a relatively large direct current, while the current flowing through the second winding 114 is mostly a relatively small alternating current generated by coupling, and the demand for the cross-sectional area of the winding is lower than that of the first winding 113. The effective cross-sectional area of the second winding 114 may be set to be smaller than the effective cross-sectional area of the first winding 113, thereby saving space and materials and reducing production costs.

Each first winding 113 includes a first end and a second end. The first end of the first winding 113 is used to lead out a first pin 131 on the first surface 111, and the second end of the first winding 113 is used to lead out a second pin 132 on the second surface 112.

When the first end of the first winding 113 is flush with the first surface 111 of the magnetic core or protrudes from the first surface 111, the first pin led out may be the first end of the first winding 113 itself. When the first end of the first winding 113 is lower than the first surface 111 of the magnetic core, the first end of the first winding may be led out of the first surface of the magnetic core through a conductive medium such as a conductive via and form the first pin. The first pin is used for electrical connection between the first end of the first winding of the magnetic core and an external device or a carrier plate. When the second end of the first winding 113 is flush with or protrudes from the second surface 112 of the magnetic core, the second pin led out may be the second end of the first winding 113 itself. When the second end of the first winding 113 is inside the magnetic core and does not reach the second surface 112 of the magnetic core, the second end of the first winding 113 may be led out of the second surface of the magnetic core through a conductive medium such as a conductive via and form the second pin. The second pin is used for the electrical connection between the second end of the first winding of the magnetic core and an external device or a carrier plate.

It should be noted that in the manufacturing process of the inductor, as shown in FIG. 1, the first pin 131 led out of the first surface 111 of the first winding 113 is SW, which is the input terminal of the current and can be directly connected to the switch unit, and the second pin 132 led out of the second surface 112 of the first winding 113 is Vo, which is the output terminal of the current and can be connected to the load. In specific implementation, the current flows in from SW and flows out from Vo. In this embodiment, the first end and the second end of the first winding are flush with the first surface and the second surface of the magnetic core, respectively. The first end of the first winding is the first pin, and the second end of the second winding is the second pin.

In the magnetic element provided in the embodiment of the present disclosure, by setting the first end of the first winding 113 to form the first pin 131 on the first surface 111 of the magnetic core 110, and the second end of the first winding 113 to form the second pin 132 on the second surface 112 of the magnetic core 110, it is realized that the first winding 113 forms pins on two opposite surfaces in the magnetic core 110, so that the input and output of the magnetic element can be separated on two opposite surfaces of the magnetic core 110, thereby ensuring the stacking setting of the magnetic element and the first switch unit when forming a power module by the magnetic element with the first switch unit subsequently, reducing the floor space of the power module, improving its power density, and the path from the switch unit to V0 is short, and the DCR loss is small.

In specific implementation, each first winding 113 and each second winding 114 are composed of one conductor, and their sectional shapes may be circular, polygonal, or irregular. The material may be flat copper wire, aluminum wire, copper-aluminum composite wire. The conductor may be formed by connecting multiple conductors in parallel, and the parallel node may be on the surface of the magnetic core, on the surface or inside of the magnetic substrate, or on the surface or inside of the carrier plate formed by the switch unit. The parallel connection can realize the flexibility of the module input and the diversification of the usage scenarios.

It should be noted that in some embodiments of the present disclosure, the magnetic core 110 is a powder core, that is, the magnetic core 110 is made of alloy magnetic powder material. In specific implementation, the powder core may be compacted from liquid powder, flaky powder or granular powder. The powder core and the first winding 113 and the second winding 114 can be integrally formed, which can increase the area of the magnetic circuit and make the magnetic element less likely to saturate. The first winding 113 and the second winding 114 can also be assembled into a prefabricated powder core. Specifically, the material of the powder core includes: at least one of nanocrystalline powder, amorphous powder, iron-nickel powder, iron-silicon-aluminum powder, iron-silicon powder, iron powder and iron-nickel-molybdenum powder. Since the saturation flux density Bs of the magnetic powder is relatively high, the magnetic element made of magnetic powder is not easy to saturate, which is conducive to the improvement of inductance performance.

It should be noted that when the magnetic element is working, the current flows in from SW and flows out from Vo, which will inevitably generate magnetic lines of force on a plane parallel to the first surface 111 (generally a horizontal plane). As shown in FIG. 3, it can be seen that if the magnetic element is flat in the case of the same volume of the magnetic core, the magnetic path length l is relatively large. Under the premise of the same magnetomotive force N×I, the magnetic field intensity H is H=N×I/l, that is, the magnetic field intensity H is relatively small. From the B-H characteristics of the magnetic material, it can be seen that the smaller the magnetic field intensity H, the smaller the magnetic flux density B, and the less likely the magnetic material is to saturate, where N is the number of turns of the first winding, and I is the current flowing through the first winding. From the above analysis, it can be seen that the flattened magnetic element setting will make the magnetic element less likely to saturate, which is beneficial to improving the inductance performance of the magnetic element. Correspondingly, in some embodiments of the present disclosure, as shown in FIG. 4, the length of the magnetic core 110 along the first direction 410 is L, the length of the magnetic core 110 along the second direction 420 is h, and the length of the magnetic core 110 along the third direction 430 is W, where the second direction 420 is perpendicular to the first surface 111 of the magnetic core 110, and h≤L, h≤W, and the first direction 410, the second direction 420 and the third direction 430 are mutually perpendicular to each other to realize the design of the above-mentioned flattened magnetic element. At the same time, the flattened magnetic element can also be used in application scenarios with restrictions on the height of the device to realize the low profile of the power module, and the application range is wide.

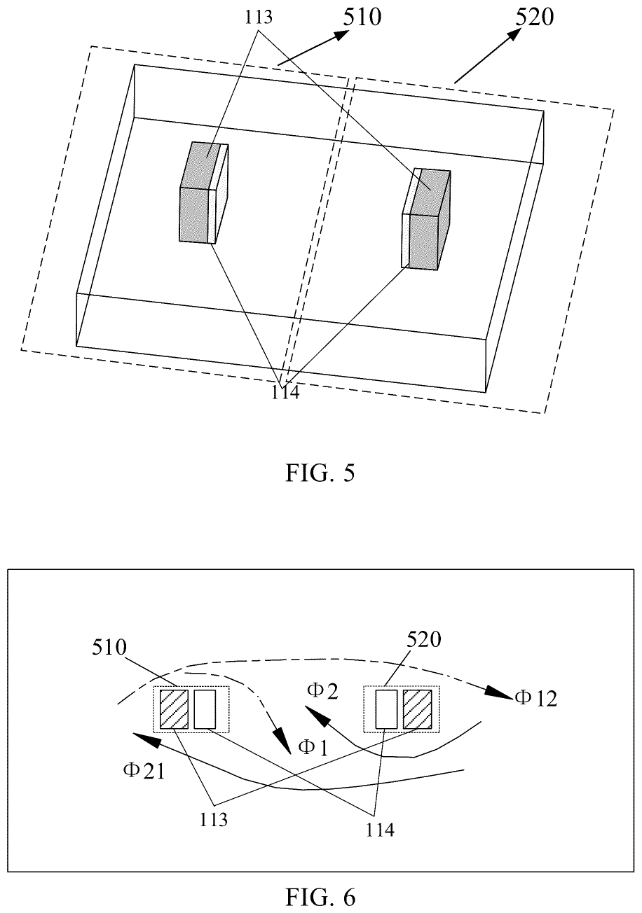

In some embodiments of the present disclosure, a magnetic element may be set as a single-phase inductor, that is, only a first winding 113 and a second winding 114 are set in the magnetic element. In some other embodiments of the present disclosure, a multi-phase inductor can also be integrated in a magnetic element to further reduce the volume and floor space of the inductor. In specific implementation, the magnetic element at least includes a first-phase inductor unit and a second-phase inductor unit. The first-phase inductor unit includes a first winding 113 and a second winding 114; the second-phase inductor unit includes a first winding 113 and a second winding 114. As shown in FIG. 5, taking the integration of two-phase inductors in the magnetic element as an example, it specifically includes: a first-phase inductor unit 510 and a second-phase inductor unit 520, and the first winding 113 of the first-phase inductor unit 510 and the first winding 113 of the second-phase inductor unit 520 are both formed with pins on two opposite surfaces (first surface 111 and second surface 112) of the magnetic core 110.

In some embodiments of the present disclosure, FIG. 6 is a schematic diagram of the magnetic flux generated by the magnetic element shown in FIG. 5. The currents in the first winding 113 of the first-phase inductor unit 510 and the first winding 113 of the second-phase inductor unit 520 flow in the same direction. The current I1 flowing into the first winding 113 of the first-phase inductor unit 510 and the first winding 113 of the second-phase inductor unit 520 generate the main magnetic flux Φ1 and the coupling magnetic flux Φ12. The current I2 flowing into the first winding 113 of the second-phase inductor unit 520 and the first winding 113 of the first-phase inductor unit 510 generate the main magnetic flux Φ2 and the coupling magnetic flux Φ21. It can be seen that the two coupling magnetic fluxes Φ12 and Φ21 are in the same direction, so that the positive coupling is generated between two phases.

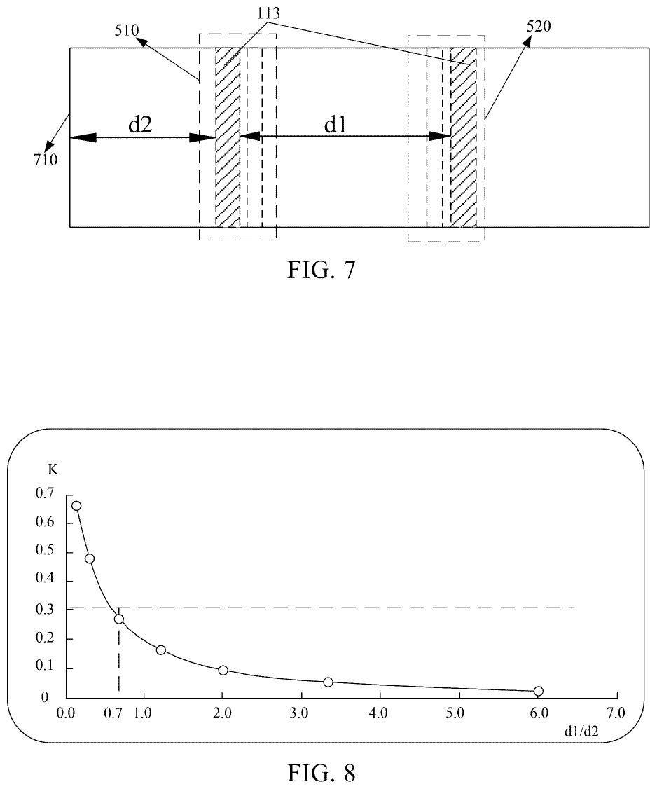

In order to further reduce the positive coupling, in a specific embodiment, referring to the sectional view shown in FIG. 7, the section is perpendicular to the first surface and passes through the first windings of the two phases in the magnetic core. In the direction parallel to the first surface on the section, the shortest distance between the outer surface of the first winding 113 of the first-phase inductor unit 510 and the outer surface of the first winding 113 of the second-phase inductor unit 520 is d1; in the direction parallel to the first surface, the shortest distance between the outer surface of the first winding 113 of the first-phase inductor unit 510 and the first edge 710 of the magnetic element is d2; where d1/d2≥0.7. It should be noted that the first edge 710 is the edge closest to the first winding 113 of the first-phase inductor unit 510 among the edges of the magnetic element connecting the first surface and the second surface in this section. As shown in FIG. 8, it is the association relationship between the coupling coefficient K between the first winding 113 of the first-phase inductor unit 510 and the first winding 113 of the second-phase inductor unit 520 of the magnetic element shown in FIG. 5 and d1/d2. It can be seen that when d1/d2≥0.7, the coupling coefficient K between the first winding 113 of the first-phase inductor unit 510 and the first winding 113 of the second-phase inductor unit 520 is expected to decrease to below 0.3. The smaller the K value, the weaker the positive coupling, which is conducive to achieving anti-coupling.

It can be understood by those skilled in the art that when a magnetic element includes at least three-phase inductor units, by analogy, it is only necessary to set the inductor unit closest to the first edge 710 of the magnetic element in the section as the first-phase inductor unit 510, determine the shortest distance d2 between the outer surface of the first winding of the first-phase inductor unit 510 and the first edge 710 of the magnetic element in the section in a direction parallel to the first surface, and determine the shortest distance between the outer surface of the first winding 113 of other phase inductor units and the outer surface of the first winding 113 of the first-phase inductor unit 510 in the section in the direction parallel to the first surface as d1ᵢ, where the value of i is an integer greater than or equal to 2, which is the number of phases of the inductor unit included in the magnetic element minus one. Ensuring d1ᵢ/d2≥0.7 can reduce the positive coupling coefficient, further improve the anti-coupling, and meet the dynamic performance.

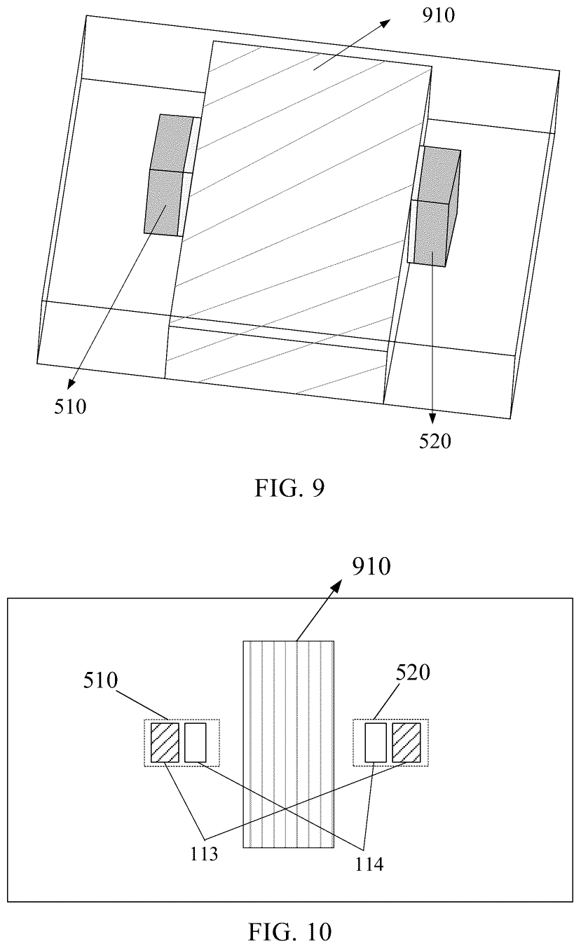

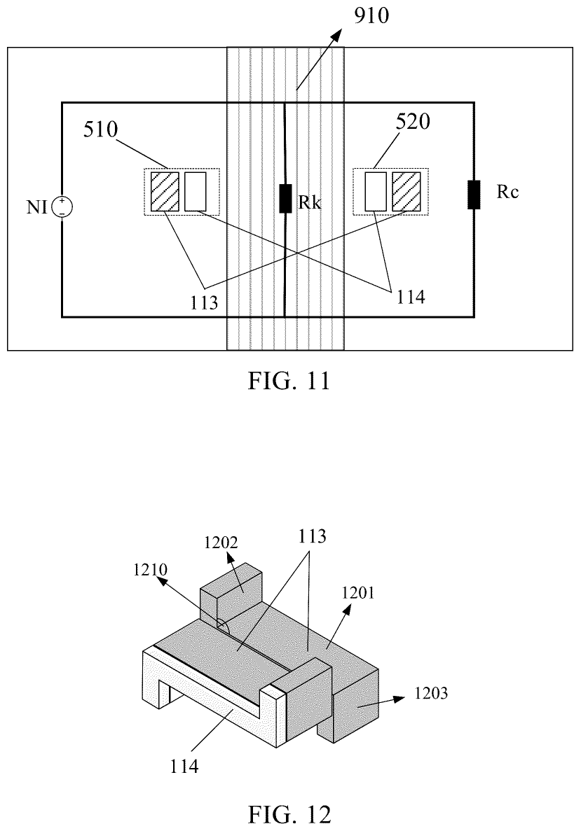

In some embodiments of the present disclosure, in order to reduce the positive coupling between multi-phase inductor units, the magnetic permeability of the magnetic core 110 between any two adjacent phase inductor units can also be increased. As shown in FIGS. 9 to 11, the arrangement of the material of the magnetic core 110 between the first-phase inductor unit 510 and the second-phase inductor unit 520 of the magnetic element shown in FIG. 5 is shown, and the reference numeral 910 in the figure indicates the part with high magnetic permeability. In these embodiments of the present disclosure, the magnetic permeability of the magnetic core 110 at least partially located between the winding of the first-phase inductor unit 510 and the winding of the second-phase inductor unit 520 is higher than the magnetic permeability of the other parts of the magnetic core 110, that is, in the section parallel to the first surface, the magnetic core with high magnetic permeability is at least partially located between the windings of the two-phase inductor units in the direction of the connection line of the two-phase first windings and in the direction perpendicular to the connection line of the two-phase first windings. In a specific implementation, the magnetic permeability of the magnetic core 110 at least partially located between the winding of the first-phase inductor unit 510 and the winding of the second-phase inductor unit 520 may be 1.2 times or more of the magnetic permeability of the other parts of the magnetic core 110. As shown in FIG. 9, the magnetic permeability of the entire magnetic core 110 between the winding of the first-phase inductor unit 510 and the winding of the second-phase inductor unit 520 is set to high magnetic permeability. That is, in the section parallel to the first surface, in the direction of the connection line of the two-phase first windings, the partial magnetic core between the windings of the two-phase inductor units has high magnetic permeability, and the partial magnetic core with high magnetic permeability is arranged through the magnetic core in a direction perpendicular to the connection line of the two-phase first windings. The direction of the connection line of the two windings in a plane can be understood as the direction of the connection line of the two centroids of the two windings in the plane. As shown in FIG. 10, the magnetic permeability of partial magnetic core 110 located between the first-phase inductor unit 510 and the second-phase inductor unit 520 is set to high magnetic permeability. It can be understood by those skilled in the art that the ratio of the partial magnetic core 110 with high magnetic permeability located between the first-phase inductor unit 510 and the second-phase inductor unit 520 to the entire magnetic core 110 between the first-phase inductor unit 510 and the second-phase inductor unit 520 can be set according to actual needs. For example, in order to reduce positive coupling and indirectly increase anti-coupling, this ratio can be appropriately increased, and the present disclosure is not limited thereto. When the first winding 113 of the first-phase inductor unit 510 is energized, a magnetic potential NI is generated. As shown in FIG. 11, the equivalent magnetic resistance Rk of the partial magnetic core 110 with high permeability is small, and the magnetic flux basically passes through R1, while the equivalent magnetic resistance Rc of the remaining magnetic core 110 is large, and only a very small amount of magnetic flux passes therethrough. The coupling coefficient between the two phases is reduced from the original 0.3 to 0.1, thereby reducing the positive coupling between the two phases and improving the anti-coupling effect, thereby improving the dynamic performance of the VRM module.

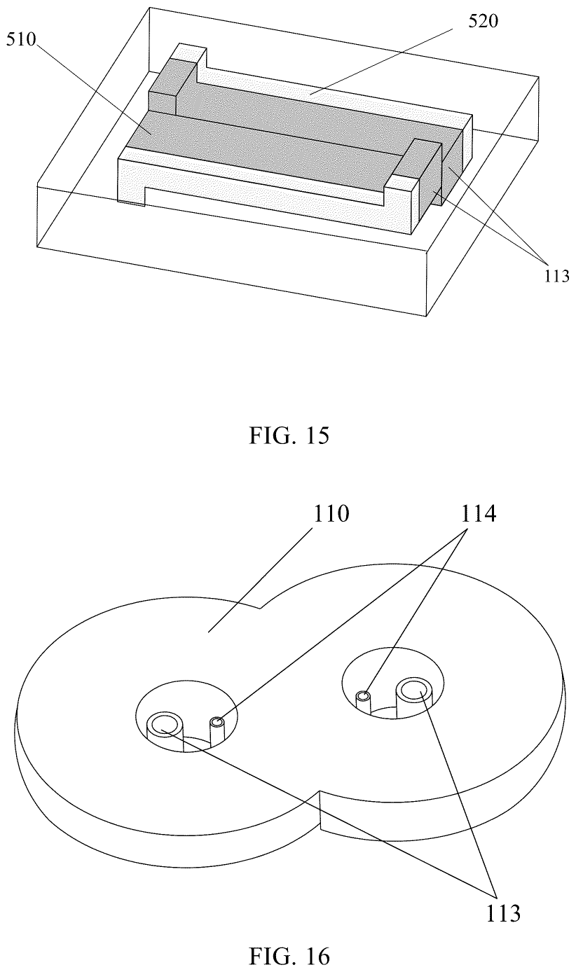

In some embodiments of the present disclosure, based on the magnetic element shown in FIG. 5, there is a vertical plane perpendicular to the first surface 111 (as shown in VP1 in FIG. 14); the projections of the first winding 113 of the first-phase inductor unit 510 and the first winding 113 of the second-phase inductor unit 520 on the vertical plane are staggered, that is, the out end of the first winding of the first-phase inductor unit on the first surface is located at the first side of the out end of the first winding of the second-phase inductor unit on the first surface, and the out end of the first winding of the first-phase inductor unit on the second surface is located at the second side of the out end of the first winding of the second-phase inductor unit, where the second side is opposite to the first side. The projections of the two-phase first windings on the vertical plane have at least one overlapping intersection, such as an X-shaped arrangement, and the out ends of the two-phase first windings on the first surface are respectively located on the left and right sides of the intersection, and the out ends of the two-phase first windings on the second surface are respectively located on the left and right sides of the intersection, or as shown in FIG. 13, the partial projections of the two-phase first windings on the vertical plane overlap continuously.

In a specific implementation, the overlap rate of the projections of the first winding 113 of the first-phase inductor unit 510 and the first winding 113 of the second-phase inductor unit 520 on the vertical plane is greater than or equal to 80% of the first winding. Since the current flow directions of the two-phase inductor units are both from the SW on the first surface 111, when the overlap rate of the projections of the first winding 113 of the first-phase inductor unit 510 and the first winding 113 of the second-phase inductor unit 520 on the vertical plane is large, the currents flowing through the two are in opposite directions on the overlap surface of the two conductors, so the magnetic flux directions generated by the currents flowing through the two are also opposite, thereby improving the anti-coupling effect. Further, in the embodiments of the present disclosure, the overlap rate of the projections of the first winding 113 and the second winding 114 of the first-phase inductor unit 510 on the vertical plane is greater than or equal to 60% of the first winding, as shown in FIG. 25; the overlap rate of the projections of the first winding 113 and the second winding 114 of the second-phase inductor unit 520 on the vertical plane is greater than or equal to 60% of the first winding. It can be understood by those skilled in the art that when the magnetic element includes a multi-phase inductor unit, the overlap rate of the projections of the first winding 113 and the second winding 114 of each phase inductor unit on the vertical plane is greater than or equal to 60% of the first winding. Further, in some specific embodiments of the present disclosure, the overlap rate of the projections of the first winding 113 and the second winding 114 of each phase inductor unit on the vertical plane may be 100% of the first winding to achieve a relatively high anti-coupling coefficient, thereby improving the dynamic performance of the module.

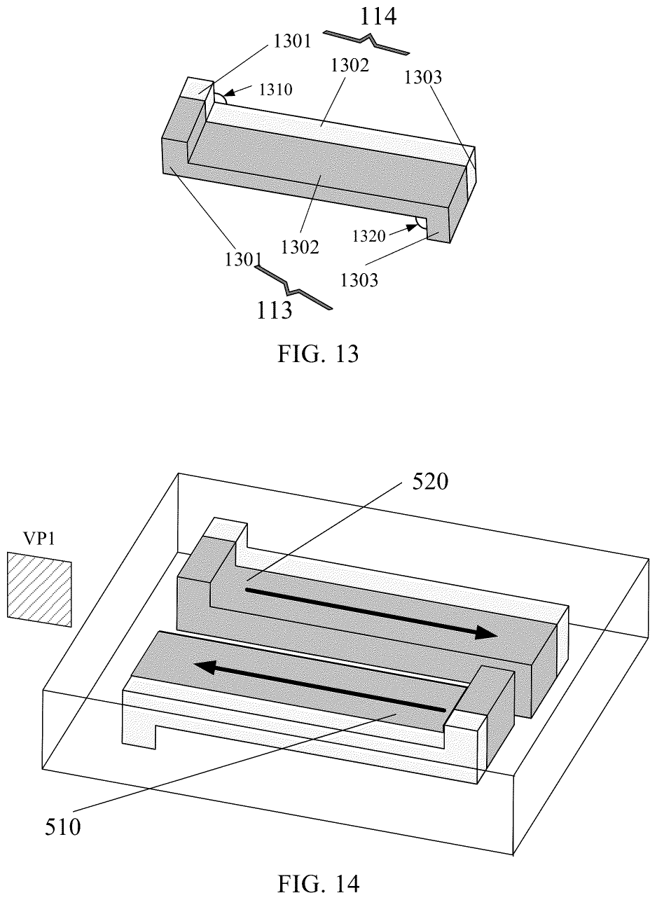

In a specific embodiment of the present disclosure, as shown in FIG. 12 (only the first winding and the second winding are shown in the figure), the magnetic element includes two first windings 113 and one second winding 114, and the two first windings 113 both include a first portion 1201 parallel to the vertical plane and a second portion 1202 and/or a third portion 1203 that form a certain angle 1210 with the first portion 1201, where the third portion 1203 and the second portion 1202 are respectively distributed at both ends of the first portion 1201. The second winding 114 is located outside one of the first windings 113, and the projections of the two first windings 113 on the vertical plane are staggered, so that the staggered position can be adjusted according to needs, thereby changing the anti-coupling coefficient.

In a specific embodiment of the present disclosure, as shown in FIG. 13, any one winding of the first winding 113 and the second winding 114 of the first-phase inductor unit 510 and the first winding 113 and the second winding 114 of the second-phase inductor unit 520 includes: a first portion 1301, a second portion 1302 and a third portion 1303, where the first portion 1301 and the third portion 1303 are located on opposite sides of the second portion 1302, the first portion 1301 and the second portion 1302 are connected to form a first angle 1310, and the third portion 1303 and the second portion 1302 are connected to form a second angle 1320, the first angle 1310 is greater than 0, and the second angle 1320 is greater than 0, for example, as shown in FIG. 13, the first angle 1310 and the second angle 1320 are both 90 degrees. The first portion 1301 is connected to the first surface 111 of the magnetic core 110, and the third portion 1303 is connected to the second surface 112 of the magnetic core 110. As can be seen from FIGS. 13 and 14, the length of each winding is set longer than the structure in FIG. 5, which makes it easier to achieve the inductance, so the magnetic permeability requirement of the magnetic core 110 can be lowered. As can be seen from FIG. 14, when the current flows through the second portion 1302 of the first winding 113 of the first-phase inductor unit 510 and the second portion 1302 of the first winding 113 of the second-phase inductor unit 520, the current directions (as shown by the arrows in FIG. 14) are opposite, and the directions of the generated magnetic flux are also opposite, thereby improving the anti-coupling effect. Furthermore, the overlap rate of the projections of the first winding 113 and the second winding 114 of the first-phase inductor unit 510 on the vertical plane is 100% of the entire winding, and the overlap rate of the projections of the first winding 113 and the second winding 114 of the second-phase inductor unit 520 on the vertical plane is 100% of the entire winding, that is, the second winding 114 of the first-phase inductor unit 510 and the second winding 114 of the second-phase inductor unit 520 are set to form pins on two opposite surfaces of the magnetic core 110.

In some embodiments of the present disclosure, the first winding 113 of the first-phase inductor unit 510 and the first winding 113 of the second-phase inductor unit 520 are arranged adjacent to each other. As shown in FIG. 15, it is a schematic diagram in which the first winding 113 of the first-phase inductor unit 510 and the first winding 113 of the second-phase inductor unit 520 are close to each other in the magnetic element including the first-phase inductor unit 510 and the second-phase inductor unit 520 of the shape shown in FIG. 13, so as to further improve the anti-coupling effect. In the specific implementation, considering the safety of the winding, an insulating material is arranged between the first winding 113 of the first-phase inductor unit 510 and the first winding 113 of the second-phase inductor unit 520, which can be achieved by coating the conductor forming the first winding 113 with a varnish film or by separately arranging an insulating layer, and the thickness of the arranged insulating layer is reduced as much as possible, for example, the thickness of the insulating material may be set to about 0.025 mm, so that the first winding 113 of the first-phase inductor unit 510 and the first winding 113 of the second-phase inductor unit 520 are in close proximity.

In some embodiments of the present disclosure, the second winding 114 of the first-phase inductor unit 510 and the second winding 114 of the second-phase inductor unit 520 are connected to each other at opposite-polarity terminals to achieve anti-coupling between the phases. In specific implementation, the second winding 114 of the first-phase inductor unit 510 and the second winding 114 of the second-phase inductor unit 520 are electrically connected on the surface of the magnetic core 110. For example, it may be achieved by setting the second winding 114 to form the pin on the surface (first surface 111 and/or second surface 112) of the magnetic core 110, and connecting the opposite-polarity terminals of the pins of the second winding of the first phase and the second winding of the second phase on the surface of the magnetic core 110. Alternatively, during the production process of the inductor, the opposite-polarity terminals of the second windings between respective phases can be connected in advance and then laminated together with the first winding and the magnetic core of respective phase. The second windings may also be connected at the opposite-polarity terminals on the surface or inside of the magnetic substrate, or on the surface or inside of the carrier plate of the switch unit. The opposite-polarity terminal connection means that the first terminal of a second winding is connected to the second terminal of another second winding, and it can be set according to actual needs.

For example, when a two-phase inductor is integrated in a magnetic element, the third pin formed on the first surface of the magnetic core by the first end of the second winding of the inductor unit of one phase is connected to the fourth pin formed on the second surface of the magnetic core by the second end of the second winding of the other phase, the fourth pin formed on the second surface by the second end of the second winding of one phase is used to be electrically connected to the carrier plate or an external device, and the third pin formed on the first surface by the first end of the second winding of the other phase is used to be electrically connected to the carrier plate or an external device.

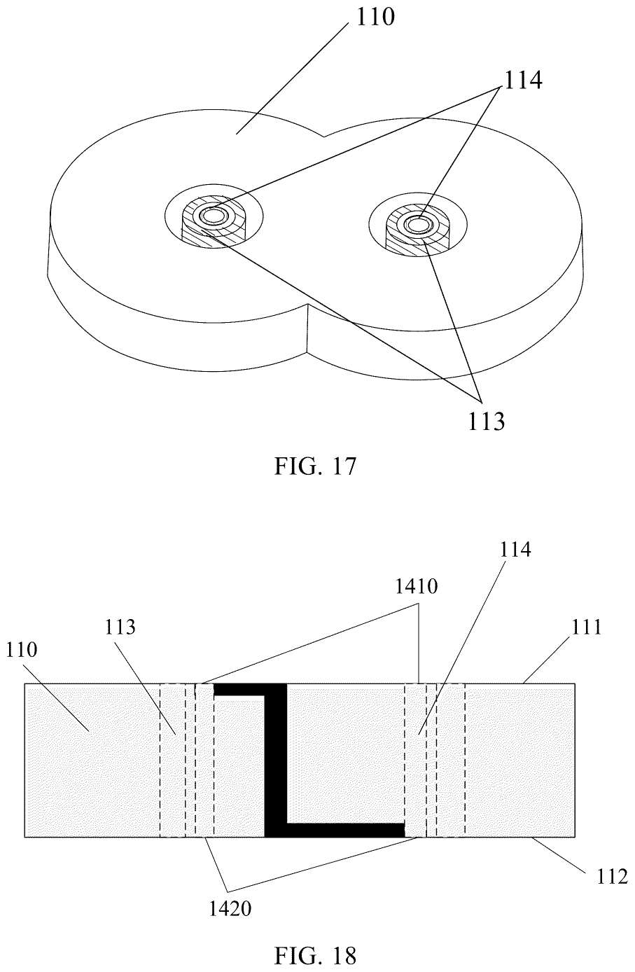

In some embodiments of the present disclosure, as shown in FIG. 16, the magnetic core 110 is 8-shaped, and at least one first winding 113 and a second winding 114 arranged adjacent to each first winding 113 are arranged inside the 8-shaped magnetic core 110. In specific implementation, as shown in FIG. 16, the magnetic core 110 and the first winding 113 and the second winding 114 can be monolithically pressed. Alternatively, the magnetic core may be monolithically pressed, the first winding 113 and the second winding 114 are welded to the magnetic substrate, and the magnetic core and the windings are assembled. Alternatively, the magnetic core 110 may be placed in the slotted insulating medium, and after the insulating medium and the magnetic core are laminated, the first winding 113 and the second winding 114 are formed by mechanical, laser drilling processes. The first winding 113 and the second winding 114 can also be realized by multiple laser holes respectively. In order to further improve the space utilization, as shown in FIG. 17, the second winding 114 arranged adjacent to each first winding 113 is arranged inside the corresponding first winding 113. In addition to the first winding 113, the second winding 114 and the magnetic core 110 being assembled, the magnetic core can also be placed in the slotted insulating material. First, the first winding 113 is formed by mechanical, laser drilling, electroplating, and resin via plug. Then, the second winding 114 is formed by mechanical, laser drilling, and electroplating in the resin-plugged via inside the first winding 113. In this embodiment, the first winding 113 and the second winding 114 can also be realized by passing through multiple laser holes respectively.

In specific implementation, the 8-shaped magnetic core 110 can be press-formed and then placed in a slotted insulating medium, or it can be formed by placing a flaky powder or a flowable liquid powder into a slotted insulating material and pressing it. This manufacturing process is not limited to the 8-shaped magnetic core, and can also be applied to magnetic cores of other shapes, such as square magnetic cores. In order to reduce the positive coupling between the two phases, all or part of the 8-shaped magnetic core 110 between the first-phase inductor unit 510 and the second-phase inductor unit 520 is set to a magnetic material with high magnetic permeability.

In some embodiments of the present disclosure, the second winding adjacent to each first winding is set inside the corresponding first winding to improve space utilization. The shape of the first winding and/or the second winding can be set to a square, rectangular, annular or 8-shaped as shown in FIG. 16, and the second winding adjacent to each first winding can be set inside the corresponding first winding. It can be understood by those skilled in the art that the above shapes are only examples and are not used to limit the scope of protection of the present disclosure.

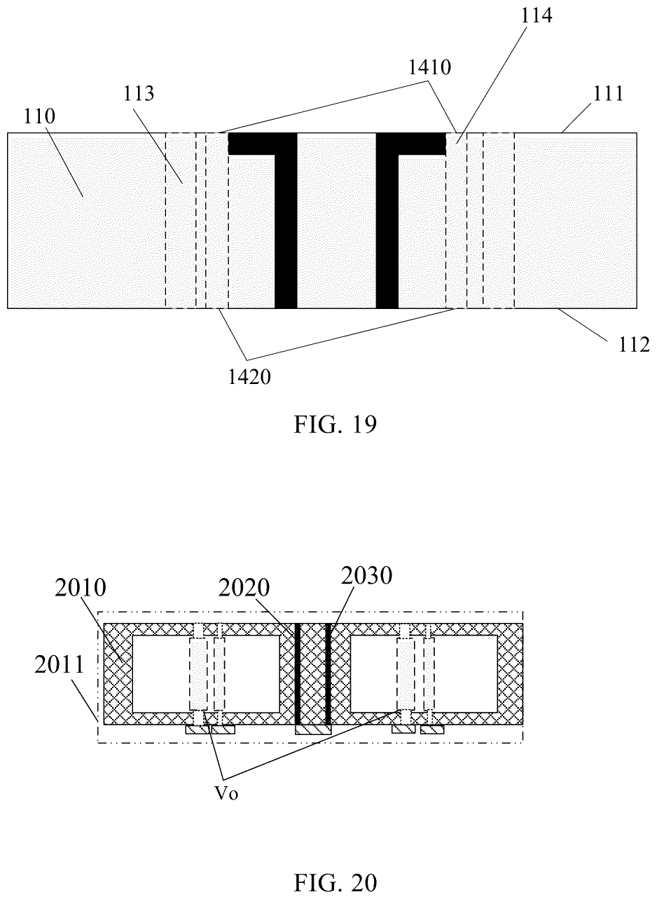

It should be noted that, in some embodiments of the present disclosure, two ends of the second winding 114 of the multi-phase inductor unit can form pins on two opposite surfaces of the magnetic core 110 for electrical connection with a carrier plate or other devices. As shown in FIG. 18, it is a schematic diagram showing that the two ends of the second winding 114 of each phase inductor unit of the magnetic element shown in FIG. 5 form pins on two opposite surfaces of the magnetic core 110, and the pins for electrical connection with a carrier plate or other devices are respectively located on both sides of the magnetic core, each second winding 114 includes a first end and a second end; the first end of each second winding forms a third pin 1410 on the first surface 111, the second end of the second winding 114 forms a fourth pin 1420 on the second surface 112, the fourth pin 1420 of the second winding 114 on the left side of the figure is arranged on the second surface of the magnetic core, and is used to be electrically connected to the carrier plate or other devices, the third pin 1410 of the second winding 114 on the left side is connected to the fourth pin 1420 of the second winding 114 on the right side through a good conductor (the black filled part in the figure), and the material of the good conductor may be copper or aluminum. The third pin 1410 of the second winding 114 on the right side is arranged on the first surface of the magnetic core, and is used to be electrically connected to the carrier plate or other devices. In some other embodiments of the present disclosure, the two ends of the second winding 114 of the multi-phase inductor unit are located on two opposite surfaces of the magnetic core to form pins, and the pins for electrical connection with the carrier plate or other devices can also be arranged on the same surface of the magnetic core 110 (the first surface 111 or the second surface 112). As shown in FIG. 19, it is a schematic diagram showing the two ends of the second winding 114 of each phase inductor unit of the magnetic element shown in FIG. 5 form pins on two opposite surfaces of the magnetic core 110, and the pins for electrical connection with the carrier plate or other devices are both located on the second surface of the magnetic core. Each second winding 114 includes a first end and a second end; the first end of each second winding 114 forms a third pin 1410 on the first surface 111, and the second end of each second winding forms a fourth pin 1420 on the second surface 112. The fourth pins 1420 of the second windings of the two phases are both on the second surface of the magnetic core, and are used to be electrically connected to the carrier plate or other devices. The third pin 1410 of each second winding 114 is led to the second surface of the magnetic core through a good conductor (the black filled part in the figure) for electrical connection with the carrier plate or other devices, and is on the same surface of the magnetic core as the fourth pin 1420. The material of the good conductor may be copper, aluminum, silver or copper-aluminum composite. It is convenient to electrically connect the pins of the second windings 114 of the multi-phase inductor unit to each other through a substrate on its surface or inside when using the magnetic element, so as to realize anti-coupling between multiple phases. In some other embodiments of the present disclosure, the two ends of the second windings 114 of the multi-phase inductor unit can also form pins on the same surface (first surface 111 or second surface 112) of the magnetic core 110. As shown in FIG. 25, each second winding 114 includes a first end and a second end. The second winding 114 of each phase inductor unit of the magnetic element is bent in the magnetic core. The first end and the second end of the second winding 114 respectively form a third pin 1410 and a fourth pin 1420 on the second surface 112 of the magnetic core. Both ends of the two-phase second winding 114 form pins on the second surface 112 of the magnetic core 110.

In some embodiments of the present disclosure, the magnetic element also includes: a signal pin and a power pin, and the signal pin and the power pin are integrated on the surface of the magnetic core. The signal pin is used to realize the transmission of the signal, and the power pin is used to realize the transmission of the power. By integrating the signal pin and the power pin on the surface of the magnetic core, the power density of the magnetic element is improved.

In some embodiments of the present disclosure, the magnetic element shown in FIG. 20 further includes: an insulating medium 2010, a signal pin 2020 and a power pin 2030, the magnetic core 110 is embedded in the insulating medium 2010 to form a magnetic substrate 2011, the signal pin 2020 is embedded in the insulating medium 2010 or arranged on the surface of the insulating medium 2010, and the power pin 2030 is embedded in the insulating medium 2010 or arranged on the surface of the insulating medium 2010. It should be noted that the signal pin 2020 is used to realize signal transmission, the power pin 2030 is used to realize power transmission, and the signal pin 2020 and the power pin 2030 are both independent of the pins of the first winding and the second winding. The first winding, the second winding, the signal PIN, and the power PIN are fabricated by: drilling in the insulating medium by mechanical or laser methods, then electroplating to form laser holes or slotted holes connected to the surface copper, and then applying solder mask printing to expose the copper surface to form a pad. In a specific implementation, the insulating medium 2010 may be a Printed Circuit Board (PCB) or a Molding material. It may be understood that the signal pin 2020 and the power pin 2030 can be set together on the surface of the magnetic core, or they can be set separately. The power pin 2030 is on the surface of the magnetic core and the signal pin 2020 is inside or on the surface of the insulating medium, or the signal pin 2020 is on the surface of the magnetic core and the power pin 2030 is on the surface or inside of the insulating medium, and further the signal pin 2020 and the power pin 2030 can both be on the surface or inside of the insulating medium. When the signal pin 2020 and/or the power pin 2030 are embedded in the insulating medium 2010, they can be formed by mechanical or laser drilling and then electroplating, or by embedding copper blocks or pin headers, or by a combination of the two processes. Specifically, the signal pin 2020 and/or the power pin 2030 can be integrally formed when the magnetic element is laminated, or can be formed by electroplated after mechanical or laser drilling on the surface of the magnetic core 110 after forming the magnetic element, or can be formed by forming a groove on the surface of the magnetic core 110 through mechanical or laser drilling, and placing a conductor in the groove, or can be integrated on the surface of the magnetic core 110 by folding the PIN, thereby improving the power density of the magnetic substrate 2011.

By adding the signal pin 2020 and/or the power pin 2030 to the magnetic element, more functions can be integrated to improve the power density of the magnetic element. Further, in some embodiments of the present disclosure, the magnetic element includes at least two-phase inductor units, and the second windings 114 of at least two-phase inductor units are connected in the insulating medium 2010 by a good conductor or on the surface of the insulating medium 2010 by a good conductor to achieve the connection of the second windings 114 between multiple inductors, thereby achieving anti-coupling among multi-phase. The second windings 114 of at least two-phase inductor units are connected on the surface of the magnetic core or the insulating medium or inside the insulating medium. The magnetic core may be placed in the slot of the insulating material after curing, or the magnetic core may be formed by placing the magnetic powder in the slot and laminating it.

In some embodiments, as shown in FIG. 20, due to manufacturing tolerances and other reasons, the first end of the first winding is located inside the magnetic core and slightly lower than the first surface of the magnetic core. The first end of the first winding is used to lead out the first pin on the first surface of the magnetic core through a conductive via. The second end of the first winding is also inside the magnetic core, slightly lower than the second surface of the magnetic core, and does not reach the second surface of the magnetic core. The second end of the first winding is used to lead out the second pin on the second surface of the magnetic core through a conductive via. At this time, the first pin and the second pin are conductive vias electrically connected to the first end and the second end of the first winding, respectively.

Based on the same inventive concept, a power module is also provided in the embodiment of the present disclosure, as described in the following embodiments. Since the principle of solving the problem in the embodiments of the power module is similar to that in the above-mentioned embodiments of the magnetic element, the implementation of the embodiments of the power module can refer to the implementation of the above-mentioned embodiments of the magnetic element, and the repeated parts will not be elaborated.

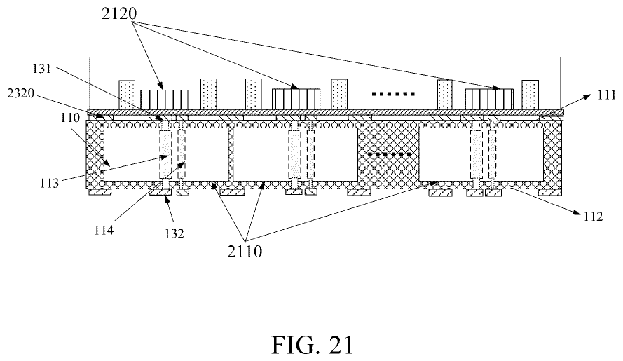

In the embodiments of the present disclosure, a power module is also provided, as shown in FIGS. 21 to 29, including at least one magnetic element 2110 of any one of the above embodiments and at least one first switch unit 2120, and may also include a combination of multiple different magnetic elements. Specifically, the number of the first switch units 2120 is k, and the number of the first windings is the same as the number of the switch units 2120, so as to achieve precise control of each phase.

The magnetic element 2110 includes: a magnetic core 110, the magnetic core 110 includes a first surface 111 and a second surface 112 arranged opposite to each other; and a first winding 113 and b second winding 114 arranged in the magnetic core 110;
where a is an integer greater than or equal to b, and b is an integer greater than or equal to 1; each first winding 113 is arranged adjacent to a second winding 114; it should be noted that the adjacent arrangement of the first winding 113 and the second winding 114 means that the first winding 113 and the second winding 114 are arranged adjacent to each other, and they may be arranged side by side, or one of them may include the other of them, for example, the first winding 113 is arranged around the second winding 114. In specific implementation, an insulating layer is also arranged between the adjacent first winding 113 and second winding 114 to improve safety and prevent the windings from being burned. It can be understood by those skilled in the art that the thickness of the insulating layer arranged between the adjacent first winding 113 and second winding 114 can be set according to actual conditions, for example, it may be 0.03 mm. The above thickness value is only for example and is not used to limit the protection scope of the present disclosure.

The effective cross-sectional area of each first winding 113 is greater than the effective cross-sectional area of each second winding 114; when the winding is composed of a single conductor, the cross-sectional area of the single conductor is its effective cross-sectional area, and when the winding is formed by multiple conductors in parallel, the sum of the cross-sectional areas of the multiple conductors constituting the winding is its effective cross-sectional area. When the first winding 113 is arranged around the second winding 114, the effective cross-sectional area of the first winding is the cross-sectional area of the current flowing through the first winding. It should be noted that, in the specific implementation, the current flowing through the first winding 113 is mostly a relatively large direct current, while the current flowing through the second winding 114 is mostly a relatively small alternating current, and the demand for the cross-sectional area of the winding is lower than that of the first winding 113. The effective cross-sectional area of the second winding 114 may be set to be smaller than the effective cross-sectional area of the first winding 113, thereby saving space and materials and reducing production costs.

Each first winding 113 includes a first end and a second end. The first end of the first winding 113 forms a first pin 131 on the first surface 111, and the second end of the first winding 113 forms a second pin 132 on the second surface 112;
k first switch units 2120 are arranged on the first surface 111 of the magnetic core 110, and each first switch unit 2120 is electrically connected to the first pin 131 of the first winding 113 formed on the first surface 111 through a slot/laser hole, and is used to control whether current flows into the corresponding first winding 113 and the phase of the flowing current.

By arranging k first switch units 2120 on the first surface 111 of the magnetic core 110, and electrically connecting each first switch unit 2120 to the first pin 131 of the first winding 113 formed on the first surface 111 through a slot/laser hole, for example, by welding, the first switch unit 2120 and the magnetic element 2110 are stacked vertically, reducing the floor space and volume of the power module, which can not only meet the requirement of miniaturization of the power module, but also improve the power density of the power module. The switch unit 2120 is directly connected to the pin 131 of the magnetic element 2012, which can reduce the length of the wire connection between the magnetic element 2110 and the first switch unit 2120, and reduce the loss during the wire connection.

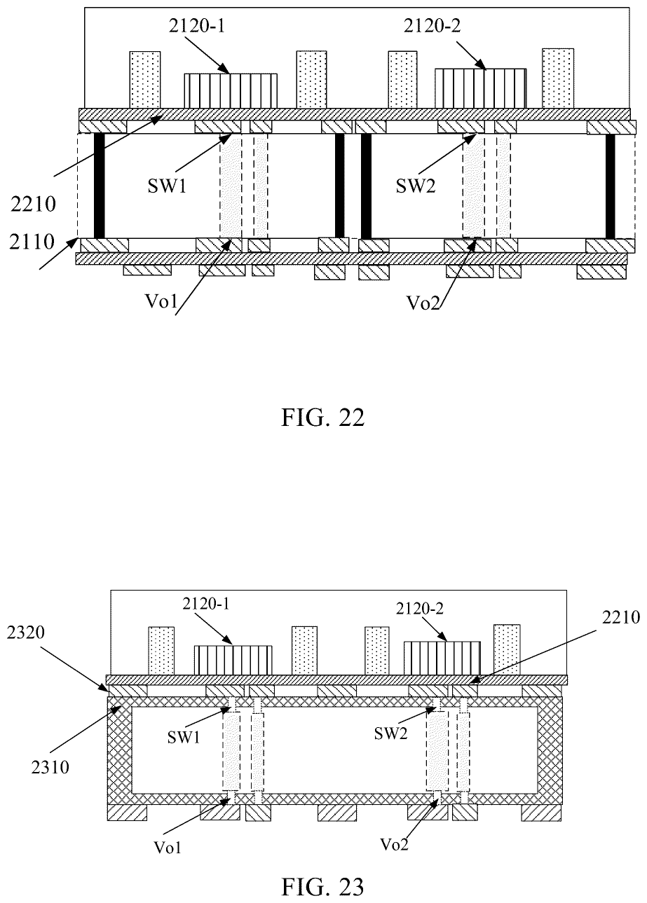

It should be noted that there are many ways to connect the first switch unit 2120 and the magnetic element 2110. In some embodiments of the present disclosure, as shown in FIG. 22, k first switch units 2120 are arranged on a carrier plate 2210 and may be connected to the carrier plate 2210 by welding. FIG. 22 includes two first switch units 2120, which are represented by 2120-1 and 2120-2 respectively. That is, the magnetic element 2110 is connected to the first switch unit 2120-1 and the first switch unit 2120-2 by the carrier plate 2210. In specific implementation, in order to integrate more functions and further improve the power density of the magnetic element 2110, the signal pin 2020 and the power pin 2030 can be arranged on the surface of the magnetic element, as shown in FIG. 20. In other embodiments of the present disclosure, the power module is shown in FIG. 23, and includes: a magnetic substrate 2310. As shown in FIG. 23, k first switch units 2120 (indicated by 2120-1 and 2120-2 in the figure) can be welded to the carrier plate 2210, and the carrier plate 2210 and the magnetic substrate 2310 are connected through the pad 2320 to realize the connection between the first switch unit 2120 and the inductor input terminal, i.e., the first pin of the first winding formed on the first surface.

In specific implementation, the k first switch units 2120 are embedded in the insulating material to form a main board together with the carrier plate 2210, where the insulating medium may be a PCB or a molding material. Further, the k first switch units 2120 may also be embedded in the insulating material with devices such as a capacitor and/or a resistor to form a main board together with the carrier plate 2210, and the switch unit 2120 is embedded in the insulating material through a plastic molding or embedded process to improve integration. The first switch unit 2120 can be completely embedded in the insulating material, or partially embedded therein so that part of it is exposed and can contact the heat sink, so that the first switch unit 2120 dissipates heat. In specific implementation, the insulating medium is formed on the carrier 2210, and k first switch units 2120 can also be directly welded on the carrier plate 2210. Further, k first switch units 2120 can also be welded on the carrier plate 2210 together with devices such as a capacitor and/or a resistor to improve integration.

It should be noted that each first winding 113 and each second winding 114 contained in the magnetic element 2110 are both composed of a conductor, and each first winding 113 and each second winding 114 can both be composed of one conductor, and its sectional shape may be circular, polygonal, or irregular. Its material may be flat copper wire, aluminum wire, copper-aluminum composite wire. The conductor may be formed by connecting multiple conductors in parallel, and the parallel node may be on the surface of the magnetic core, the surface or inside of the magnetic substrate, or the surface or inside of the carrier plate formed by the switch unit. The parallel connection can achieve the flexibility of module input and the diversification of usage scenarios. When multiple conductors are connected, they can be connected on the surface of the magnetic element 2110, on the surface or inside of the magnetic substrate, or on the surface or inside of the carrier plate of the switch unit, which is not limited here and can be set according to actual needs.

In some embodiments of the present disclosure, each second winding 114 includes a first end and a second end, and the first end of each second winding 114 forms a third pin 1410 on the first surface 111, and the second end of the second winding 114 forms a fourth pin 1420 on the second surface 112. Alternatively, the first end and the second end of each second winding 114 respectively form a third pin 1410 and a fourth pin 1420 on the first surface 111. Alternatively, the first end and the second end of each second winding 114 respectively form a third pin 1410 and a fourth pin 1420 on the second surface 112.

In some embodiments of the present disclosure, referring to the definitions of the first direction 410, the second direction 420, and the third direction 430 in FIG. 4, the length of the magnetic core 110 included in the magnetic element 2110 along the first direction 410 is L, and the length of the magnetic core 110 along the second direction 420 is h; the length of the magnetic core 110 along the third direction 430 is W, the second direction 420 is arranged perpendicular to the first surface 111 of the magnetic core 110, and on a section parallel to the first surface, the distance between two adjacent surfaces of the first winding and the second winding of the same phase in the first direction 410 is the distance between the first winding and the second winding of each phase, and the distance is less than ⅕ of the length of the magnetic core along the first direction, and the adjacent arrangement of the first winding and the second winding can reduce the magnetic path length, increase the inductance, and increase the coupling between the first winding and the second winding. The direction perpendicular to the first surface of the magnetic core is the second direction 420, the direction of the straight line passing through the centroid of the first winding and the centroid of the second winding of the same phase on the section is the first direction 410, and the third direction 430 is perpendicular to both the first direction and the second direction. The first direction 410, the second direction 420 and the third direction 430 are perpendicular to each other. The first winding may be a primary winding, and the second winding may be a secondary winding. h≤L, h≤W, the first direction 410 and the second direction 420 and the third direction 430 are mutually perpendicular to each other, so as to realize the flattened magnetic element 2110, thereby realizing the low profile of the power module, making the application range wider. The flattened magnetic element setting will make the magnetic element less likely to saturate, which is conducive to improving the inductance performance of the magnetic element.

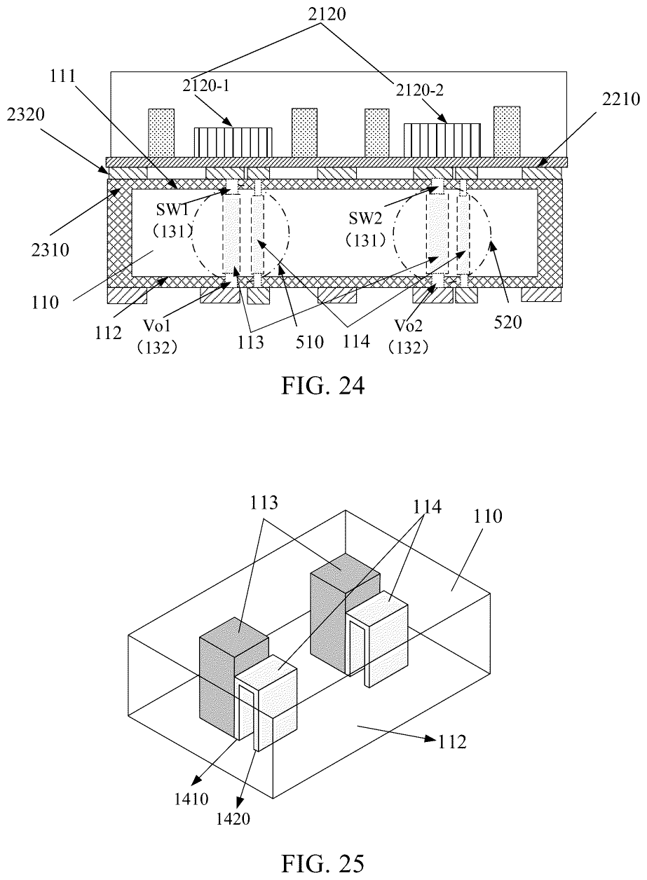

It should be noted that in order to further reduce the floor space and volume of the power module and improve the integration of the power module, the magnetic element 2110 can integrate multiple inductors, that is, the first windings and the second windings of the multi-phase inductor units are set in a magnetic core, that is, the magnetic element 2110 includes at least two-phase inductor units. In some embodiments of the present disclosure, as shown in FIG. 24, the magnetic element 2110 includes a first-phase inductor unit 510 and a second-phase inductor unit 520; where the first-phase inductor unit 510 includes a first winding 113 and a second winding 114; the second-phase inductor unit 520 includes a first winding 113 and a second winding 114. Two first switch units 2120 are included: a first switch unit 1 (2120-1) and a first switch unit 2 (2120-2). The first switch unit 1 (2120-1) and the first winding 113 of the first-phase inductor unit 510 are electrically connected to the first pin 131 (SW1) formed on the first surface 111 of the magnetic core 110 through a pad to control the on/off and current phase of the input current of the first-phase inductor unit 510. The first switch unit 2 (2120-2) and the first winding 113 of the second-phase inductor unit 520 are electrically connected to the first pin 131 (SW2) formed on the first surface 111 of the magnetic core 110 through the pad to control the on/off and current phase of the input current of the second-phase inductor unit 520.

In some embodiments of the present disclosure, the second pin 132 of each first winding 113 forms the output terminal of the power module, and the first pin 131 of each first winding 113 forms the input terminal of the power module. As shown in FIG. 24, the second pin 132 (Vo1) formed on the second surface 112 of the magnetic core 110 by the first winding 113 of the first-phase inductor unit 510 is one output terminal of the power module, and the second pin 132 (Vo2) formed on the second surface 112 of the magnetic core 110 by the first winding 113 of the second-phase inductor unit 520 is another output terminal of the power module.

In some embodiments of the present disclosure, there is a section perpendicular to the first surface and passing through the two-phase first windings in the magnetic core. In the section, along the direction parallel to the first surface, the shortest distance between the outer surface of the first winding 113 of the first-phase inductor unit 510 and the outer surface of the first winding 113 of the second-phase inductor unit 520 is d1, and along the direction parallel to the first surface, the shortest distance between the outer surface of the first winding 113 of the first-phase inductor unit 510 and the first edge of the magnetic element 2110 is d2; where d1/d2≥0.7. It should be noted that the first edge is the edge closest to the first winding 113 of the first-phase inductor unit 510 among the edges of the magnetic element 2110 connecting the first surface and the second surface in the section, so as to further reduce the positive coupling between the multi-phase inductor units, thereby improving the dynamic performance of the VRM module including the power module.

In some embodiments of the present disclosure, the magnetic permeability of the magnetic core 110 located at least partially between the first-phase inductor unit 510 and the second-phase inductor unit 520 is higher than the magnetic permeability of the other parts of the magnetic core 110, so as to further improve the anti-coupling between the multi-phase inductor units, thereby improving the dynamic performance of the VRM module including the power module.

In some embodiments of the present disclosure, there is a vertical plane perpendicular to the first surface 111; the projections of the first winding 113 of the first-phase inductor unit 510 and the first winding 113 of the second-phase inductor unit 520 on the vertical plane are staggered, that is, the out end of the first winding 113 of the first-phase inductor unit 510 on the first surface is located at the first side of the out end of the first winding 113 of the second-phase inductor unit 520 on the first surface, and the out end of the first winding 113 of the first-phase inductor unit 510 on the second surface is located at the second side of the out end of the first winding 113 of the second-phase inductor unit 520 on the second surface, which is opposite to the first side, so as to achieve the effect of adjusting the anti-coupling between the multi-phase inductor units. Specifically, the overlap rate of the projections of the first winding 113 and the second winding 114 of the first-phase inductor unit 510 on the vertical plane is greater than or equal to 60% of the first winding; the overlap rate of the projections of the first winding 113 and the second winding 114 of the second-phase inductor unit 520 on the vertical plane is greater than or equal to 60% of the first winding, so as to achieve a relatively high anti-coupling coefficient, thereby improving the dynamic performance of the module. For example, as shown in FIG. 25, it is a schematic diagram showing that the overlap rate of the projections of the first winding 113 and the second winding 114 on the vertical plane is equal to 60% of the first winding.

In some embodiments of the present disclosure, the second winding 114 of the first-phase inductor unit 510 and the second winding 114 of the second-phase inductor unit 520 are connected to each other at opposite-polarity terminals to achieve anti-coupling between the phases. The opposite-polarity terminals are connected to each other, that is, the first end of one second winding is connected to the second end of another second winding. In a specific implementation, the second winding 114 of the first-phase inductor unit 510 is electrically connected to the second winding 114 of the second-phase inductor unit 520 on the surface of the magnetic core 110. For example, it may be achieved by setting the second winding 114 to form the pin on the surface (first surface 111 and/or second surface 112) of the magnetic core 110, and connecting the opposite-polarity terminals of the pins of the first-phase second winding and the second-phase second winding on the surface of the magnetic core 110. Alternatively, during the inductor production process, the opposite-polarity terminals of the second windings between respective phases can be connected in advance and then laminated together with the first winding and the magnetic core of respective phase. The second windings can also be connected at the opposite-polarity terminals on the surface or inside of the magnetic substrate, or on the surface and inside of the carrier plate of the switch unit. The arrangement can be made according to actual needs.

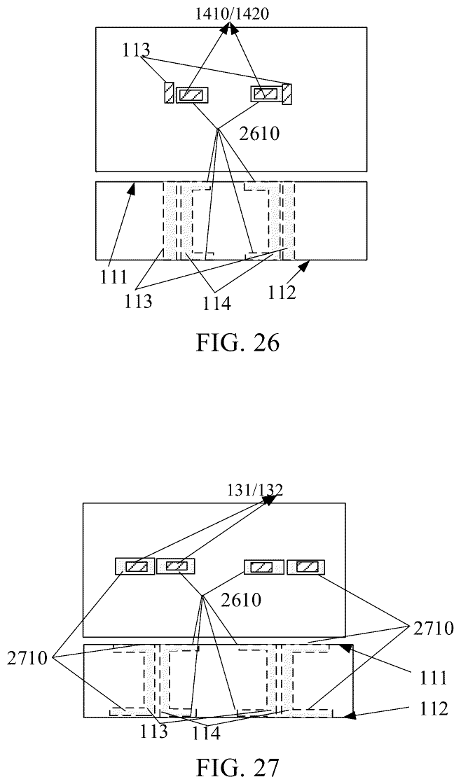

It should be noted that the first winding 113 and the second winding 114 are arranged adjacent to each other. In the process, due to the short distance between the two, it is easy to cause problems such as drilling and breaking the disk. After the laser hole is electroplated, it causes a short circuit between the windings or excessive leakage current, affecting safety. In some embodiments of the present disclosure, each second winding 114 forms a first bending portion on the first surface 111 and the second surface 112, and the winding includes a conductor part and an insulating material coated on the surface of the conductor, such as a varnish film. Part of the insulating material on the surface of the first bending portion of the winding is removed, so that the conductor part of the first bending portion is exposed to form the third pin 1410 and the fourth pin 1420; where the projection area formed by the first bending portion 2610 on the first surface 111 is larger than the projection area formed by the exposed conductor part on the first surface 111; the projection area formed by the first bending portion on the second surface 112 is larger than the projection area formed by the exposed conductor part on the second surface 112, that is, each second winding 114 is bent on the first surface 111 and the second surface 112 of the magnetic core 110; and/or each first winding 113 forms a second bending portion on the first surface 111 and the second surface 112, the winding includes a conductor part and an insulating material coated on the surface of the conductor, such as a varnish film. Part of the insulating material on the surface of the second bending portion of the winding is removed, so that the conductor part of the second bending portion is exposed to form the first pin 131 and the second pin 132. The projection area formed by the second bending portion on the first surface 111 is larger than the projection area formed by the exposed conductor part on the first surface 111; the projection area formed by the second bending portion on the second surface 112 is larger than the projection area formed by the exposed conductor part on the second surface 112, that is, each first winding 113 is bent on the first surface 111 and the second surface 112 of the magnetic core 110. For example, as shown in FIG. 26, the side view of the first winding 113 in the magnetic core is I-shaped and pins are led out on the upper and lower sides of the magnetic core, and the side view of the second winding 114 is in the shape of “[” or “]”, and first bending portions 2610 are formed on two opposite surfaces (the first surface 111 and the second surface 112), and the first bending portion 2610 is parallel to the first surface 111/the second surface 112, that is, the second winding 114 is bent 90° to form a pin. The bending area is larger than the exposed conductor area. The exposed area can be formed into a pin independently to be electrically connected to the substrate or external device, or can be embedded and then formed into a laser hole or slot by mechanical, laser, etc. to be electrically connected to the surface of the insulating medium to form an independent PIN. The projection area formed by the first bending portion 2610 on the first surface 111 is larger than the projection area formed by the exposed conductor part on the first surface 111, and the projection area formed by the first bending portion 2610 on the second surface 112 is larger than the projection area formed by the exposed conductor part on the second surface 112. By such setting, the exposed conductor part is inside the bending portion, and the distance between the exposed conductor part and the edge of the bending portion is at least 0.005 mm. The withstand voltage is good, and the withstand voltage reduction between the windings due to grinding of the magnetic core 110 or the magnetic substrate is avoided. In the process of forming a PIN through a hole drilled in an insulating medium, since laser drilling has a certain process tolerance, by setting the projection area formed by the first bending portion 2610 on the first surface 111 to be larger than the projection area formed by the exposed portion of the conductor on the first surface 111, and the projection area formed by the first bending portion 2610 on the second surface 112 to be larger than the projection area formed by the exposed portion of the conductor on the second surface 112, it can also avoid the problem that the laser hole of the second winding 114 is too large and short-circuited with the first winding 113, or the laser hole hits the powder material of the magnetic core 110 to cause the disk to break, resulting in low reliability.

As shown in FIG. 27, the side view of the first winding 113 in the magnetic core presents a “]” shape, and the side view of the second winding 114 presents a “[” shape. On the basis of FIG. 23, each first winding 113 forms second bending portions 2710 on the first surface 111 and the second surface 112, and the winding includes a conductor part and an insulating material coated on the surface of the conductor, such as a varnish film. Part of the insulating material on the surface of the first bending portion of the winding is removed, so that the conductor part of the second bending portion 2710 is exposed to form the first pin 131 and the second pin 132; where the projection area formed by the second bending portion 2710 on the first surface 111 is larger than the projection area formed by the exposed portion of the conductor on the first surface 111; the projection area formed by the second bending portion 2710 on the second surface 112 is larger than the projection area formed by the exposed portion of the conductor on the second surface 112, so that there is a certain insulating medium between the second winding 114 and the first winding 113, and the voltage resistance is good, avoiding the reduction of the voltage resistance between the windings due to the grinding of the magnetic core or the magnetic substrate; it can also avoid the laser hole of the first winding 113 being too large and short-circuiting with the second winding 114, or the laser hole hitting the powder material of the magnetic core causing the disk to break, resulting in low reliability. Furthermore, on the same surface of the magnetic core, the bending direction of the second bending portion 2710 is opposite to the bending direction of the first bending portion 2610, so as to further increase the distance between the first winding 113 and the second winding 114 at the exposed position of the pin conductor on the surface of the magnetic core, thereby improving the withstand voltage between the windings as much as possible and avoiding the occurrence of short circuit between the windings and disk breakage as much as possible.

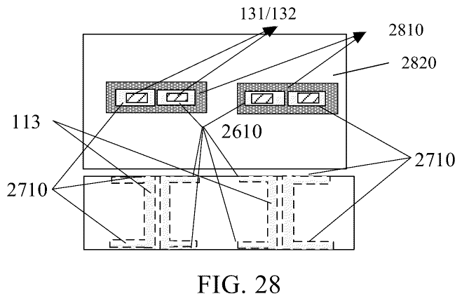

In some embodiments of the present disclosure, as shown in FIG. 28, another insulating material 2810 can be added between the surface insulating material of the winding and the powder material of the magnetic core on the basis of FIG. 27 to ensure that when the magnetic core or the magnetic substrate is ground, the conductor winding, such as copper, can be extended and drawn to form a copper wire, which can extend into the insulating material and not extend to the powder material 2820 of the magnetic core, so that the magnetic powder between the first windings 113 of the two-phase inductor unit will not be short-circuited due to the extended copper wire, thereby improving the withstand voltage between the two phases.

In some embodiments of the present disclosure, the magnetic core 110 is in an 8-shaped shape, and at least one first winding 113 and a second winding 114 arranged adjacent to each first winding 113 are arranged inside the 8-shaped magnetic core 110.

In specific implementation, as shown in FIG. 16, the magnetic core 110 and the first winding 113 and the second winding 114 can be monolithically pressed. Alternatively, the magnetic core can be monolithically pressed, the first winding 113 and the second winding 114 are welded to the carrier plate, and the magnetic core and the windings are assembled. Alternatively, the magnetic core 110 can be placed in a slotted insulating medium, and after the insulating medium and the magnetic core are laminated, the first winding 113 and the second winding 114 are formed by mechanical and laser drilling processes. The first winding 113 and the second winding 114 can also be realized by multiple laser holes respectively. In order to further improve the space utilization, as shown in FIG. 16, the second winding 114 arranged adjacent to each first winding 113 is arranged inside the corresponding first winding 113. In addition to the first winding 113, the second winding 114, and the magnetic core 110 being assembled, the magnetic core can also be placed in the slotted insulating medium. First, the first winding 113 is formed by mechanical, laser drilling, electroplating, and resin via plug, and then the second winding 114 is formed by mechanical, laser drilling, and electroplating in the resin-plugged via inside the first winding 113. In this embodiment, the first winding 113 and the second winding 114 can also be realized by passing through a plurality of laser holes respectively. In specific implementation, the 8-shaped magnetic core 110 can be press-formed and then placed in the slotted insulating medium, or it can be formed by placing flaky powder or flowable liquid powder in the slotted insulating medium and pressing it. The manufacturing process is not limited to the 8-shaped magnetic core, and can also be applied to magnetic cores of other shapes, such as square magnetic cores. In order to improve the anti-coupling effect, the entire or part of the 8-shaped magnetic core 110 between the first-phase inductor unit 510 and the second-phase inductor unit 520 can also be set to a magnetic material with high magnetic permeability.

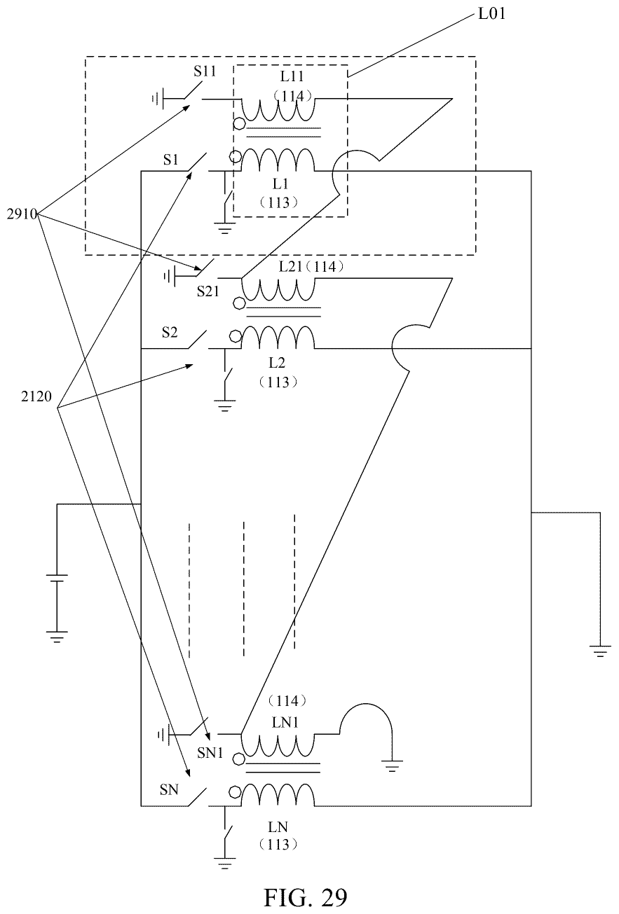

In some embodiments of the present disclosure, the power module also includes at least one second switch unit; at least one second switch unit is connected in series with at least one second winding 114 to ensure that when the power module is used, the state of the second switch unit can be switched to be connected or disconnected according to different dynamic performance requirements and efficiency requirements, and the second winding 114 connected thereto can be controlled. As shown in FIG. 29, it is a circuit schematic diagram of connecting N-phase inductor units with N first switch units 2120 (S1, S2, . . . , SN), and setting N second switch units 2910 (S11, S21, . . . , SN1) to connect with the second winding 114 in the two-phase inductor units. Taking the first-phase inductor unit L01 as an example, it includes the second winding L11 and the first winding L1. The first switch unit can realize the input and phase of each phase current, and the second switch unit controls the number of coupled phases. According to the dynamic and efficiency requirements, different numbers of first switch units and second switch units can be closed, and the number of first switch units connected can be the same as or different from the number of second switch units. The closing and disconnection of the first switch unit and the second switch unit can be flexibly adjusted according to the power size. In some embodiments of the present disclosure, the first switch units S1, S2, . . . , S8 can be closed, the 8-phase first switch units are connected to the inductor unit, and the second switch units S11, S21, . . . , S81 are closed, realizing the coupling of the 8-phase power module.

Based on the same inventive concept, a power supply system is also provided in the embodiment of the present disclosure, including: at least two power modules of any one of the above embodiments; each power module at least includes one phase independent inductor unit and a first switch unit 2120; it should be noted that the power supply system can be a VRM power supply system, which can be applied to VRM power supplies used in data centers, server motherboards, AI accelerator cards, and supercomputer CPUs.

One end of the first winding of the independent inductor unit in each power module is connected to the first switch unit of the power module, and the other end of the first winding is connected to the load. The second windings of each power module are connected through a carrier plate, such as connecting them to each other through a board card to achieve anti-coupling of multiple power modules. Alternatively, they can also be connected to each other through the carrier plate where the switch unit is located. Further, if multiple inductors are buried together to form a magnetic substrate, the second windings can also be connected through the magnetic substrate.

Each phase independent inductor unit includes: a magnetic core 110, the magnetic core 110 includes a first surface 111 and a second surface 112 arranged opposite to each other; a first winding 113 and a second winding 114, the first winding 113 and the second winding 114 are arranged adjacent to each other, and the first winding 113 and the second winding 114 are arranged in the magnetic core 110; the first winding 113 includes a first end and a second end, the first end of the first winding 113 forms a first pin 131 on the first surface 111, and the second end of the first winding 113 forms a second pin 132 on the second surface 112.

The first switch unit 2120 is arranged on the first surface 111 of the magnetic core 110; the first switch unit 2120 is electrically connected to the first pin 131 formed by the first winding 113; the second windings 114 of respective phase inductor units are connected in series to achieve multi-phase indirect anti-coupling, providing a better dynamic performance of the VRM power supply system.

As shown in FIG. 30, it is a circuit connection of a power module included in the power supply system, where the power module includes N-phase inductor units 3010 and N first switch units 2120, and each phase inductor unit 3010 and a first switch unit 2120 are vertically stacked as shown in FIG. 21, so that each phase inductor unit 3010 and the first switch unit 2120 can be directly connected, with a short connection path, small loss, and high heavy load efficiency.

The power module provided in the embodiments of the present disclosure realizes the stacking arrangement of the first switch unit and the magnetic element by arranging the first switch unit on the first surface of the magnetic core. Accordingly, the first end of the first winding in the magnetic element is used to lead out the first pin on the first surface, and the first pin is directly connected to the switch unit as the input terminal of the module, and the second end of the first winding is used to lead out the second pin on the second surface, and is directly connected to the load as the output terminal of the module, to realize the double-sided pin output of the magnetic element, so as to realize the circuit connection when the first switch unit and the magnetic element are vertically stacked, thereby reducing the impedance between the input terminal and the output terminal and improving the efficiency. The floor space of the power module is further reduced, thereby improving the power density of the VRM.

Those skilled in the art can understand that various aspects of the present disclosure can be implemented as a system, method or program product. Therefore, various aspects of the present disclosure can be specifically implemented in the following forms, namely: a complete hardware implementation, a complete software implementation (including firmware, microcode, etc.), or an implementation combining hardware and software aspects, which can be collectively referred to as “circuit”, “module” or “system” here. It should be noted that although several modules or units of the device for action execution are mentioned in the above detailed description, such division is not mandatory. In fact, according to the embodiments of the present disclosure, the features and functions of two or more modules or units described above can be embodied in one module or unit. On the contrary, the features and functions of a module or unit described above can be further divided into multiple modules or units to be embodied.

In addition, although the steps of the method in the present disclosure are described in a specific order in the drawings, this does not require or imply that the steps must be performed in this specific order, or that all the steps shown must be performed to achieve the desired results. Additionally or alternatively, some steps can be omitted, multiple steps can be combined into one step for execution, and/or one step can be decomposed into multiple steps for execution, etc.

Through the description of the above implementations, it is easy for those skilled in the art to understand that the example implementations described here can be implemented by software or by combining software with necessary hardware. Therefore, the technical solutions according to the implementations of the present disclosure can be embodied in the form of a software product, which can be stored in a non-transitory storage medium (which can be a CD-ROM, a USB flash drive, a mobile hard disk, etc.) or on a network, and includes several instructions to enable a computing device (which can be a personal computer, a server, a mobile terminal, or a network device, etc.) to execute the methods according to the implementations of the present disclosure.

After considering the specification and practicing the contents disclosed here, those skilled in the art will easily think of other implementations of the present disclosure. The present disclosure is intended to cover any variation, use or adaptation of the present disclosure, which follows the general principles of the present disclosure and includes common knowledge or customary technical means in the technical field not disclosed in the present disclosure. The specification and embodiments are to be regarded as exemplary only, and the true scope and spirit of the present disclosure are indicated by the appended claims.

What is claimed is:

1. A magnetic element, comprising:
a magnetic core, the magnetic core comprising a first surface and a second surface arranged opposite to each other; and
n first winding and m second winding arranged in the magnetic core;
wherein n is an integer greater than or equal to m, and m is an integer greater than or equal to 1;
each of the first winding is arranged adjacent to a corresponding second winding;
an effective cross-sectional area of each of the first winding is greater than an effective cross-sectional area of each of the second winding;
each of the first winding comprises a first end and a second end, the first end of the first winding is used to lead out a first pin on the first surface, and the second end of the first winding is used to lead out a second pin on the second surface.

2. The magnetic element according to claim 1, wherein a length of the magnetic core along a first direction is L, a length of the magnetic core along a second direction is h, and a length of the magnetic core along a third direction is W, wherein the second direction is arranged perpendicular to the first surface of the magnetic core;
wherein h≤L, h≤W, and the first direction is perpendicular to the second direction and the third direction respectively.

3. The magnetic element according to claim 1, wherein the magnetic element comprises a first-phase inductor unit and a second-phase inductor unit;
wherein the first-phase inductor unit comprises a first winding and a second winding;
the second-phase inductor unit comprises a first winding and a second winding.

4. The magnetic element according to claim 3, wherein a section is perpendicular to the first surface, and the section passes through the first winding of the first-phase inductor unit and the second winding of the second-phase inductor unit, and in the section, along a direction parallel to the first surface, a shortest distance between an outer surface of the first winding of the first-phase inductor unit and an outer surface of the first winding of the second-phase inductor unit is d1, and along the direction parallel to the first surface, a shortest distance between the outer surface of the first winding of the first-phase inductor unit and a first edge of the magnetic element is d2;
wherein d1/d2≥0.7;
the first edge is an edge closest to the first winding of the first-phase inductor unit among edges of the magnetic element connecting the first surface and the second surface in the section.

5. The magnetic element according to claim 3, wherein a magnetic permeability of the magnetic core at least partially located between the first-phase inductor unit and the second-phase inductor unit is higher than a magnetic permeability of other part of the magnetic core.

6. The magnetic element according to claim 3, wherein a vertical plane is perpendicular to the first surface;
projections of the first winding of the first-phase inductor unit and the first winding of the second-phase inductor unit on the vertical plane are arranged in a staggered manner.

7. The magnetic element according to claim 6, wherein an overlap rate of projections of the first winding and the second winding of the first-phase inductor unit on the vertical plane is greater than or equal to 60%;
an overlap rate of projections of the first winding and the second winding of the second-phase inductor unit on the vertical plane is greater than or equal to 60%.

8. The magnetic element according to claim 3, wherein the first winding of the first-phase inductor unit and the first winding of the second-phase inductor unit are adjacently arranged.

9. The magnetic element according to claim 3, wherein the second winding of the first-phase inductor unit is electrically connected to the second winding of the second-phase inductor unit.

10. The magnetic element according to claim 9, wherein the second winding of the first-phase inductor unit and the second winding of the second-phase inductor unit are electrically connected on a surface of the magnetic core.

11. The magnetic element according to claim 3, wherein the magnetic core is 8-shaped, and at least one of the first winding and the second winding arranged adjacent to each of the first winding are arranged inside the 8-shaped magnetic core.

12. The magnetic element according to claim 1, wherein the second winding arranged adjacent to each of the first winding is arranged inside a corresponding first winding.

13. The magnetic element according to claim 1, wherein each of the second winding comprises a first end and a second end;
the first end of each of the second winding forms a third pin on the first surface, and the second end of each of the second winding forms a fourth pin on the second surface;
or, the first end and the second end of each of the second winding respectively form the third pin and the fourth pin on the first surface;
or, the first end and the second end of each of the second winding respectively form the third pin and the fourth pin on the second surface.

14. The magnetic element according to claim 1, wherein each of the first winding and each of the second winding are composed of conductors;
the first winding and/or the second winding is respectively one of the conductors or is respectively formed by connecting a plurality of the conductors in parallel.

15. The magnetic element according to claim 1, wherein the magnetic core is a powder core;
wherein a material of the powder core comprises: at least one of nanocrystalline powder, amorphous powder, iron-nickel powder, iron-silicon-aluminum powder, iron-silicon powder, iron powder or iron-nickel-molybdenum powder.

16. The magnetic element according to claim 1, further comprising: a signal pin and a power pin;
wherein the signal pin and the power pin are integrated on a surface of the magnetic core.

17. The magnetic element according to claim 1, further comprising: an insulating medium, a signal pin and a power pin;
wherein the magnetic core is embedded in the insulating medium to form a magnetic substrate;
the signal pin is embedded in the insulating medium or arranged on a surface of the insulating medium;
the power pin is embedded in the insulating medium or arranged on the surface of the insulating medium.

18. The magnetic element according to claim 17, wherein the magnetic element comprises at least two-phase inductor units, and the second windings of the at least two-phase inductor units are electrically connected in the insulating medium or on the surface of the insulating medium.

19. A power module, comprising:
at least one magnetic element and k first switch unit;
wherein the magnetic element comprises: a magnetic core, the magnetic core comprises a first surface and a second surface arranged oppositely; and a first winding and b second winding arranged in the magnetic core;
wherein a is an integer greater than or equal to b, and b is an integer greater than or equal to 1; each of the first winding is arranged adjacent to a corresponding second winding; k is an integer greater than or equal to 1, and k is equal to a;
an effective cross-sectional area of each of the first winding is greater than an effective cross-sectional area of each of the second winding;
each of the first winding comprises a first end and a second end, the first end of the first winding is used to lead out a first pin on the first surface, and the second end of the first winding is used to lead out a second pin on the second surface;
the k first switch unit is arranged on the first surface of the magnetic core, and each of the first switch unit is electrically connected to the first pin led out by a corresponding first winding on the first surface.

20. The power module according to claim 19, wherein the magnetic element is embedded in an insulating medium to form a magnetic substrate;
the magnetic substrate comprises a signal pin and a power pin;
k first switch unit is arranged on the magnetic substrate and is electrically connected to the magnetic substrate.

21. The power module according to claim 20, wherein the power module further comprises a carrier plate, and k first switch unit is electrically connected to the magnetic substrate through the carrier plate.

22. The power module according to claim 21, wherein the magnetic element comprises a first-phase inductor unit and a second-phase inductor unit;
wherein the first-phase inductor unit comprises a first winding and a second winding;
the second-phase inductor unit comprises a first winding and a second winding.

23. The power module according to claim 22, wherein the second winding of the first-phase inductor unit and the second winding of the second-phase inductor unit are electrically connected on a surface of the magnetic core.

24. The power module according to claim 23, wherein each of the second winding comprises a first end and a second end, the first end of each of the second winding forms a third pin on the first surface, and the second end of the second winding forms a fourth pin on the second surface;
or, the first end and the second end of each of the second winding respectively form the third pin and the fourth pin on the first surface;
or, the first end and the second end of each of the second winding respectively form the third pin and the fourth pin on the second surface.

25. The power module according to claim 24, wherein each of the second winding forms first bending portions on the first surface and the second surface, and conductor parts of the first bending portions are exposed to form the third pin and the fourth pin;
wherein a projection area formed by the first bending portion on the first surface is larger than a projection area formed by the exposed conductor part on the first surface; a projection area formed by the first bending portion on the second surface is larger than a projection area formed by the exposed conductor part on the second surface;
and/or, each of the first winding forms second bending portions on the first surface and the second surface, and conductor parts of the second bending portions are exposed to form the first pin and the second pin;
wherein a projection area formed by the second bending portion on the first surface is larger than a projection area formed by the exposed conductor part on the first surface; a projection area formed by the second bending portion on the second surface is larger than a projection area formed by the exposed conductor part on the second surface.

26. The power module according to claim 19, further comprising at least one second switch unit; wherein the at least one second switch unit is connected to at least one of the second winding.

27. The power module according to claim 19, wherein the second pin of each of the first winding forms an output terminal of the power module, and the first pin of each of the first winding forms an input terminal of the power module.
